(19) United States
(12) Patent Application Publication
(10) Pub. No.: US 2025/0010250 A1
(43) Pub. Date: Jan. 9, 2025

(54) DEVICE AND METHOD FOR GAS INFUSION

(71) Applicant: HYDROGEN TECH IP PTY LIMITED AS TRUSTEE FOR HYDROGEN TECH IP TRUST, Sydney, New South Wales (AU)

(72) Inventors: James WILSON, Manunda, Queensland (AU); Kjell KLINGVALL, Manunda, Queensland (AU)

(21) Appl. No.: 18/702,132

(22) PCT Filed: Nov. 24, 2022
(86) PCT No.: PCT/AU2022/051406

§ 371 Date: Apr. 17, 2024

(30) Foreign Application Priority Data
Nov. 25, 2021 (AU) 2021903807

(51) Int. Cl. B01F 21/20; B01F 23/21; B01F 23/232; B01F 25/00; B01F 25/433; B01F 35/00

(52) U.S. Cl. CPC B01F 21/20; B01F 23/211; B01F 23/214; B01F 23/2323; B01F 25/4338; B01F 35/561; B01F 2025/913

(57) ABSTRACT

A device for dissolving a gas in a liquid is provided, the device comprising a device body, the device body comprising a liquid inlet; a liquid outlet; a plurality of substantially conical dissolving chambers located between the liquid inlet and the liquid outlet. The device may comprise a plurality of chamber connectors of or connected with the dissolving chambers. Each of the plurality of conical dissolving chambers may comprise a wider end towards the liquid outlet, the wider end comprising a chamber outlet for flow of liquid out of the dissolving chamber; and a narrower end towards the liquid inlet, the narrower end comprising a chamber inlet for flow of liquid into the dissolving chamber. The plurality of chamber connectors may define a substantially longitudinally straight passage extending through the plurality of dissolving chambers. Also provided is a related method of dissolving a gas in a liquid.

### CROSS REFERENCE TO RELATED APPLICATIONS

The present application is a national stage application of International Application No. PCT/AU2022/051406, filed Nov. 24, 2022, which claims priority to Australian Patent Application No. 2021903807, filed Nov. 25, 2021, the entire contents of which are incorporated herein by reference in their entirety.

### FIELD

This invention relates to gases dissolved in liquids. More particularly, the invention relates to a device for increasing the concentration of a dissolved gas in a liquid, although without limitation thereto.

### BACKGROUND

In recent years, substantial research has been dedicated to cellular effects of molecular hydrogen (alternatively referred to as H₂, dihydrogen, and hydrogen gas).

Molecular hydrogen is now well-established to have biological activity, and can act as an antioxidant, anti-inflammatory, and anti-apoptotic agent. In the last decade, the application of molecular hydrogen has been shown to have wide-ranging potential for treatment of human diseases, with beneficial effects observed in more than 170 disease models including ischemia/reperfusion injury, metabolic syndrome, inflammation, and cancer (see, Tao, G., et al. (2019). Acta biochimica et biophysica Sinica, 51(12), 1189-1197). Molecular hydrogen is also considered to have applications in agriculture (see, e.g. Zulfiqar, F., et. al. (2021). Planta, 254(3), 1-14) such as in the context of plant and animal health and productivity.

Various strategies for deploying molecular hydrogen exist. The use of liquids (typically aqueous liquids) containing concentrated molecular hydrogen forms the basis of several approaches. For example, liquids containing concentrated molecular hydrogen may be ingested by, or applied as a bath or wash, to humans or other animals, or sprayed onto field or orchard crops.

Molecular oxygen (O₂ or oxygen gas) is another gas that is deployed for its biological properties. Although oxygen gas is often administered directly (e.g. to assist with respiration), liquids containing concentrated molecular oxygen can have application in therapeutic (see, e.g. Roe, D. F., et al. (2010). Journal of Surgical Research, 159(1), e29-e36) and agricultural (see, e.g. Bhattarai, S. P., et al. (2005). Advances in Agronomy, 88, 313-377) contexts. The application of concentrated molecular oxygen also offers potential benefits for aquaculture (see, e.g. Mallya, Y. J. (2007). The United Nations University Fisheries Training Programme, Final Project) and environmental remediation (see, e.g. Shi, W., et al. (2018). Environmental science & technology, 52(15), 8712-8717).

New approaches optimised for producing liquids containing relatively high concentrations of dissolved molecular hydrogen and/or molecular oxygen would be desirable, given the wide-ranging existing and potential applications of such solutions. It could be particularly desirable to develop new approaches capable of producing liquids containing comparatively stably dissolved molecular hydrogen and/or molecular oxygen.

More generally, the dissolving of gases in liquids has application across a range of technology areas. For example, the dissolving of gases in fuel solutions has application for modifying combustion characteristics, which can assist with efficiency during burning and/or safety during storage. Accordingly, it could be particularly desirable to develop new approaches broadly suitable for dissolving of gases in liquids.

The reference to prior art in the background is not and should not be taken as an acknowledgement or suggestion that the referenced prior art forms part of the common general knowledge in Australia or in any other country.

### SUMMARY

A first aspect of the invention provides a device for dissolving a gas in a liquid, the device comprising a liquid inlet; a plurality of dissolving chambers; and a liquid outlet, wherein the plurality of dissolving chambers are located between the liquid inlet and the liquid outlet.

Suitably, the plurality of dissolving chambers comprise, or are connected with, one or more chamber connectors. In embodiments, the plurality of dissolving chambers comprise, or are connected with, a plurality of chamber connectors. In embodiments, the chamber connectors are or comprise connecting channels.

Suitably, the liquid inlet of the device facilitates entry of the liquid into the device. Suitably, the liquid outlet of the device facilitates exit of the liquid from the device.

Suitably, the dissolving chambers of the device facilitate dissolving the gas in the liquid, wherein the concentration of the dissolved gas is higher in the liquid when exiting the device relative to the liquid when entering the device. In embodiments, the chamber connectors of or connected with the dissolving chambers facilitate dissolving the gas in the liquid.

Suitably, the dissolving chambers of the device facilitate reducing bubble size of the dissolved gas in the liquid, wherein average bubble size of the dissolved gas is lower in the liquid when exiting the device relative to the liquid when entering the device. In embodiments, the chamber connectors of or connected with the dissolving chambers facilitate reducing bubble size of the dissolved gas in the liquid.

Suitably, the dissolving chambers of the device are in fluid connection with the liquid inlet and the liquid outlet, wherein the liquid can flow from the liquid inlet to the liquid outlet through the plurality of dissolving chambers.

In embodiments, the liquid can flow from the liquid inlet to the liquid outlet through each of the plurality of dissolving chambers successively. In embodiments, the liquid can flow through each of the plurality of dissolving chambers successively via the chamber connectors.

Suitably, the device of the first aspect facilitates vortexing of the liquid. In embodiments, the device facilitates substantially continuous vortexing of the liquid from the liquid inlet to the liquid outlet. In embodiments, the liquid inlet of the device facilitates vortexing of the liquid. In embodiments, the dissolving chambers of the device facilitate vortexing of the liquid. In embodiments, the chamber connectors of the device facilitate vortexing of the liquid.

Suitably, the device of the first aspect facilitates cavitation of the liquid. In embodiments, the device facilitates intermittent cavitation of the liquid, such as temporospatially intermittent cavitation of the liquid.

In embodiments, the dissolving chambers facilitate cavitation of the liquid. In embodiments, the chamber connectors facilitate cavitation of the liquid. In embodiments, the device facilitates intermittent cavitation of the liquid, such as temporospatially intermittent cavitation of the liquid, within the chamber connectors.

The device of the first aspect suitably comprises a device body. In embodiments, the device body comprises the liquid inlet; the liquid outlet; and the dissolving chambers. In embodiments, the device body comprises the chamber connectors.

In embodiments, the device body of the device of the first aspect is an elongated device body. The device body may be substantially longitudinally straight.

In embodiments, the device body of the device of the first aspect is a unitary device body.

In embodiments, the device body of the device of the first aspect is a modular device body.

The fluid inlet of the device of the first aspect may be of a first end portion of the device body. The first end portion may be a base portion of the device body.

The first end or base portion of the device body may comprise a substantially conical chamber comprising a wider first or bottom end; and a narrower second or top end. Suitably, the narrower second end of the substantially conical chamber is located away from the fluid inlet of the device.

In embodiments, the wider first end of the substantially conical chamber of the first end portion of the device body comprises an outer region or rim. In embodiments, the outer region or rim is a substantially flat outer region or rim. In embodiments, the outer region or rim is a substantially rounded outer region or rim.

In embodiments, the substantially conical chamber of the first end portion of the device body is substantially heart or heart-like shaped in longitudinal section. In embodiments, the wider first end of the conical chamber is a substantially toroidal end.

The wider first end of the conical chamber of the first end portion of the device body may be partly or substantially completely open, or partly or substantially completely closed.

In embodiments, the first end portion of the device body comprises a first end portion cap or lid, or the like. Suitably, the first end cap portion or lid can be fitted and removed, to convert the first end portion of the device body between a partly or substantially completely closed configuration and a partly or substantially completed closed configuration.

In embodiments wherein the wider first end of the conical chamber of the first end portion of the device body is partly or substantially completely open, the fluid inlet of the device may be of or comprise the open wider end of the conical chamber.

In embodiments wherein the wider first end of the conical chamber of the first end portion of the device body is partly or substantially completely closed, the first end or base portion of the device body may comprise a floor adjacent the wider first end of the conical chamber. The floor may be a substantially flat floor. The floor may be a substantially rounded floor.

In embodiments, the fluid inlet is positioned at or near the floor adjacent the wider first end of the conical chamber of the first end portion of the device body. In embodiments, the fluid inlet is positioned at or near the rounded outer region of the conical chamber of the first end portion of the device body. The fluid inlet of the device may be lateral to the floor and/or the outer region or rim of the conical chamber of the first end portion of the device body.

In embodiments, the fluid inlet of the device is adapted to receive or direct the liquid substantially centrally into the conical chamber of the first end portion of the device body.

In embodiments, the fluid inlet is adapted to receive or direct the liquid substantially into or against the outer region or rim of the conical chamber of the first end portion of the device body.

In embodiments, the fluid inlet is adapted to receive or direct the liquid substantially across the floor of the first end portion of the device body.

The fluid inlet of the device may be adapted to receive or direct the liquid into the first end portion of the device body to facilitate vortexing of the liquid.

Suitably, the first end portion of the device body comprises a first end portion outlet facilitating flow of the liquid from the first end portion to the dissolving chambers of the device. In embodiments, the first end portion outlet is at or near the narrower second end of the conical chamber of the first end portion of the device body.

The fluid outlet of the device of the first aspect may be of a second end portion of the device body. The second end portion may be a tip portion of the device body.

The second end or tip portion of the device body may comprise a substantially conical chamber comprising a wider first or bottom end; and a narrower second or top end. In embodiments, the narrower first end of the conical chamber of the second end portion of the device body is located away from the fluid outlet of the device.

The second end portion of the device body may comprise a nozzle. In embodiments, the fluid outlet of the device is of the nozzle of the second end portion. In embodiments, the wider first end of the conical chamber of the second end portion of the device body is at or near the nozzle of the second end portion.

The plurality of dissolving chambers of the device of the first aspect may comprise at least 2, at least 3, at least 4, at least 5, at least 6, at least 7, at least 8, at least 9, or at least 10 dissolving chambers. In some embodiments, the plurality of dissolving chambers comprises at least 15 or at least 20 dissolving chambers.

In embodiments, the device of the first aspect comprises between 3 and 10 dissolving chambers.

In embodiments, the device of the first aspect comprises between 10 and 25 dissolving chambers.

The plurality of dissolving chambers may comprise a first end dissolving chamber towards the liquid inlet of the device; a second end dissolving chamber towards the liquid outlet of the device; and at least one central dissolving chamber between the first end dissolving chamber and the second end dissolving chamber.

Suitably, each of the plurality of dissolving chambers of the device of the first aspect comprises a chamber inlet for flow of the liquid into the dissolving chamber; and a chamber outlet for flow of the liquid out of the dissolving chamber.

In embodiments, one or more, or each of the plurality of dissolving chambers is a substantially conical chamber, comprising a wider first or bottom end; and a narrower second or top end.

In embodiments, the wider first end of the substantially conical chamber comprises a rounded outer region or rim. In embodiments, the substantially conical chamber is substantially heart or heart-like shaped in longitudinal section. In embodiments, the wider first end of the conical chamber is a substantially toroidal end.

In embodiments, the narrower end of one or more, or each, of the plurality of dissolving chambers is towards the fluid inlet of the device, and the wider end of one or more, or each, of the plurality of dissolving chambers is towards the fluid outlet of the device.

In embodiments, the chamber inlet of one or more, or each, of the plurality of dissolving chambers is at or near the narrower second end of the substantially conical chamber. Suitably, the chamber inlet is, or comprises, an inlet aperture. In embodiments, the inlet aperture is a substantially circular aperture.

In embodiments, the chamber outlet of one or more, or each, of the plurality of dissolving chambers is at or near the wider first end of the substantially conical chamber. The chamber outlet may be located substantially centrally relative to the wider first end of the substantially conical chamber. The rounded outer region of the wider first end of the substantially conical chamber may surround the chamber outlet. Suitably, the chamber outlet is, or comprises, an outlet aperture. In embodiments, the outlet aperture is a substantially circular aperture.

One or more, or each of the plurality of dissolving chambers of the device of the first aspect may have different or substantially the same characteristics of shape and/or size. In embodiments, each of the plurality of dissolving chambers is of substantially the same size. In embodiments, each of the plurality of dissolving chambers is of substantially the same shape.

In embodiments, each of the plurality of dissolving chambers is a substantially conical chamber comprising: a substantially toroidal wider first end, the first end comprising a chamber outlet, the chamber outlet comprising a substantially circular aperture; and a narrower second end, the narrower second end comprising a chamber inlet, the chamber inlet comprising a substantially circular aperture.

In embodiments, the plurality of dissolving chambers of the device comprises, or is connected with, a plurality of chamber connectors. Suitably, the plurality of chamber connectors are of the device body.

The plurality of chamber connectors of the device may comprise at least 2, at least 3, at least 4, at least 5, at least 6, at least 7, at least 8, at least 9, or at least 10 chamber connectors. In some embodiments, the plurality of chamber connectors comprises at least 15 or at least 20 chamber connectors.

In embodiments, the device comprises between 3 and 10 chamber connectors.

In embodiments, the device comprises between 10 and 25 chamber connectors.

Suitably, each of the plurality of chamber connectors of the device of the first aspect is connected to the chamber inlet or the chamber outlet of at least one of the dissolving chambers of the device.

In embodiments, one or more of the chamber connectors of the device extends between the chamber inlet of one of the plurality of dissolving chambers and the chamber outlet of another of the plurality of dissolving chambers. Suitable, the one and the other of the plurality of dissolving chambers are adjacent dissolving chambers.

Suitably, the chamber connectors of or connected with the dissolving chambers of the device are or comprise channels. In embodiments, one or more, or each of the chamber connectors comprise substantially cylindrical channels.

In embodiments, the plurality of dissolving chambers of the device comprise, or are connected with, a plurality of cylindrical chamber connectors.

In embodiments, the plurality of dissolving chambers of the device comprise, or are connected with, a plurality of cylindrical chamber connectors, wherein a respective one of the plurality of cylindrical chamber connector extends between the circular aperture of the chamber outlet of a respective one of the plurality of dissolving chambers and the circular aperture of the chamber inlet of a respective another of the plurality of dissolving chambers.

In embodiments, the chamber connectors define a passage or borehole extending through the device body of the device of the first aspect. Suitably, the passage or borehole extends through each of the plurality of dissolving chambers of the device body. In embodiments, the passage or borehole is a substantially central passage or borehole. In embodiments, the passage or borehole is a substantially longitudinally straight passage or borehole. In embodiments, the passage or borehole is a substantially cylindrical passage or borehole.

The dissolving chambers of the device of the first aspect may be of a central portion of the device body of the device. In embodiments wherein the dissolving chambers comprise, or are connected with, the chamber connectors, suitably the chamber connectors are of the central portion of the device body.

In embodiments, the central portion of the device body is an elongated central portion. In embodiments, the central portion of the device body is a substantially longitudinally straight central portion.

In embodiments, the chamber connectors define a passage or borehole extending through the central portion of the device body. Suitably, the passage or borehole extends through each of the plurality of dissolving chambers. In embodiments, the passage or borehole is a substantially central passage or borehole. In embodiments, the passage or borehole is a substantially longitudinally straight passage or borehole. In embodiments, the passage or borehole is a substantially cylindrical passage or borehole.

The device of the first aspect may comprise a gas inlet, for entry of gas into the device. Suitably, the gas inlet facilitates entry of the gas into the device body for dissolving of the gas in the liquid. Suitably, the gas inlet facilitates entry of the gas into the plurality of dissolving chambers of the device.

In embodiments, the gas inlet is of the first end or base portion of the body of the device. In embodiments, the gas inlet is of the first end portion cap or lid.

In embodiments, the gas inlet is positioned at or near the floor of the first end or base portion of the device. The gas inlet may comprise an aperture or orifice extending through the floor, facilitating entry of the gas into the substantially conical cavity of the first end portion of the device body. In embodiments, the gas inlet or aperture thereof is located substantially centrally within the floor.

In embodiments, the gas inlet is positioned at or near the outer region or rim of the substantially conical chamber of the first end portion of the device body. In embodiments, the gas inlet is positioned substantially centrally relative to the wider first end of the substantially conical chamber, wherein the outer region or rim surrounds the gas inlet.

In embodiments wherein the device body of the first aspect is a unitary body, suitably, the first end or base portion of the body comprising the fluid inlet; the second end or tip portion of the body comprising the fluid outlet; and the central portion of the body comprising the plurality of dissolving chambers, are together of unitary construction.

In embodiments wherein the device body of the device of the first aspect is a modular body, suitably, one or more of the first end portion of the body, or a part thereof; the second end portion of the body, or a part thereof; or the central portion of the body, or a part thereof, are of separate or separatable modules of the body.

In embodiments, the modular body of the device of the first aspect comprises at least 2, at least 3, at least 4, at least 5, at least 6, at least 7, at least 8, at least 9, at least 10, or at least 11 separatable modules. In embodiments, the plurality of separatable modules of the modular body comprises at least 15 or at least 20 separatable modules.

In embodiments, the modular body of the device comprises between 3 and 10 separatable modules.

In embodiments, the modular body of the device comprises between 10 and 25 separatable modules.

In embodiments wherein the device body of the first aspect is a modular body, the first end or base portion of the device body may be of, or comprise, a separatable module of the device body. The separatable module of the device body comprising the first end portion may comprise part of the central portion of the device body.

In embodiments, the separatable module of the device body comprising the first end portion comprises a part of the central portion of the device body comprising at least one of the plurality of dissolving chambers. In embodiments, the separatable module of the device body comprising the first end portion comprises a part of the central portion of the device body comprising a part of one of the plurality of dissolving chambers.

In embodiments, the separatable module of the device body comprising the first end portion comprises a part of the central portion of the device body comprising at least one of the chamber connectors. In embodiments, the separatable module of the device body comprising the first end portion comprises a part of the central portion of the device body comprising a part of one of the chamber connectors.

In embodiments wherein the device body is a modular body, the second end or tip portion of the device body may be of, or comprise, a separatable module of the body. The separatable module of the device body comprising the second end portion may comprise part of the central portion of the device body.

In embodiments, the separatable module of the device body comprising the second end portion comprises a part of the central portion of the device body comprising at least one of the plurality of dissolving chambers. In embodiments, the separatable module of the device body comprising the second end portion comprises a part of the central portion of the device body comprising a part of one of the plurality of dissolving chambers.

In embodiments, the separatable module of the device body comprising the second end portion comprises a part of the central portion of the device body comprising at least one of the chamber connectors. In embodiments, the separatable module of the device body comprising the second end portion comprises a part of the central portion of the device body comprising a part of one of the chamber connectors.

In embodiments wherein the device body of the device is a modular body, the central portion of the device body may be of, or comprise, a separatable module of the body.

In embodiments, the central portion of the device body comprises a plurality of separatable modules. The plurality of separatable modules of the central portion of the device body may comprise at least 2, at least 3, at least 4, or at least 5 separatable modules. In embodiments, the central portion of the device body comprises between about 2 and about 9 separatable modules.

Suitably, each of the plurality of separatable modules of the central portion of the device body of the device of the first aspect comprises at least a part of one of the dissolving chambers. In embodiments, each of the plurality of separatable modules comprises at least one of the dissolving chambers. In embodiments, each of the plurality of separatable modules comprises a part of two of the dissolving chambers.

Suitably, each of the plurality of separatable modules of the central portion of the device body of the device of the first aspect comprises at least a part of one of the chamber connectors. In embodiments, each of the plurality of separatable modules comprises at least one of the chamber connectors. In embodiments, each of the plurality of separatable modules comprises a part of two of the chamber connectors.

A second aspect of the invention provides a method of manufacturing a device for dissolving a gas in a liquid, the method including a step of arranging a plurality of dissolving chambers between a liquid inlet and a liquid outlet. The method of the second aspect may include a step of arranging one or more chamber connectors between the liquid inlet and the liquid outlet.

In embodiments, the method of manufacturing the device according to the second aspect is a method of forming the dissolving chambers, the liquid inlet, and the liquid outlet, and, optionally, the chamber connectors, as a plurality of separatable modules.

In embodiments, the method of manufacturing the device according to the second aspect is a method of forming the dissolving chambers, the liquid inlet, the liquid outlet, and, optionally, the chamber connectors, as a unitary body.

A third aspect of the invention provides a device for dissolving a gas in a liquid manufactured according to the method of the second aspect. The device of the third aspect may be the device of the first aspect.

A fourth aspect of the invention provides a method of adjusting a modular device for dissolving a gas in a liquid, the method including a step of adding and/or removing one or more modules of a modular device the one or more modules comprising a dissolving chamber or a part thereof. In embodiments, the method of the fourth aspect includes a step of adding and/or removing one or more modules of the modular device comprising a chamber connector or a part thereof.

The modular device adjusted according to the method of the fourth aspect may be the device of the first or third aspects.

A fifth aspect of the invention provides a system for dissolving a gas in a liquid, the system comprising the device of the first or third aspects connected to at least one of a pipe or hose; an impellor; a pump; and a hydrolysis machine.

A sixth aspect of the invention provides a method of dissolving a gas in a liquid, the method including a step of passing fluid comprising liquid and gas through a plurality of dissolving chambers, to thereby dissolve the gas in the liquid.

Suitably, the method of dissolving the gas in the liquid of the sixth aspect is a method of increasing concentration of gas dissolved in the liquid. In embodiments, the method of dissolving gas in the liquid of the sixth aspect is a method of decreasing average bubble size of gas dissolved in the liquid.

Suitably, the step of passing the fluid through the plurality of dissolving chambers according to the method of the sixth aspect is a step of successively passing the fluid through each of the respective dissolving chambers. In embodiments, the concentration of the gas dissolved in the liquid increases in each of the respective dissolving chambers. In embodiments, the average bubble size of the gas dissolved in the liquid decreases in each of the respective dissolving chambers.

In embodiments, the method of the sixth aspect includes a step of passing the fluid through one or more or a plurality of chamber connectors, wherein the chamber connectors are of or connected with the plurality of dissolving chambers.

In embodiments, the method of the sixth aspect includes a step of expanding and contracting the fluid when passing the fluid through each of the plurality of dissolving chambers.

In embodiments, the method of the sixth aspect includes a step of expanding the fluid in each of the plurality of dissolving chambers after passage of the fluid through a respective narrowed dissolving chamber inlet.

In embodiments, the method of the sixth aspect includes a step of contracting the fluid during passage of the fluid from each of the plurality of dissolving chambers through a respective narrowed dissolving chamber outlet.

In embodiments, the method of the sixth aspect includes a step of passing contracted fluid into each of the chamber connectors.

Suitably, the method of the sixth aspect includes a step of rotating the fluid in each of the dissolving chambers. The method of the sixth aspect may include a step of vortexing the fluid in each of the dissolving chambers.

In embodiments, the method of the sixth aspect includes a step of rotating the fluid in each of the chamber connectors. The method of the sixth aspect may include a step of vortexing the fluid in each of the chamber connectors.

In embodiments, the method of the sixth aspect includes a step of substantially continuously rotating the fluid through the dissolving chambers and the chamber connectors.

In embodiments, the method of the sixth aspect includes a step of substantially continuously vortexing the fluid through the dissolving chambers and the chamber connectors.

In embodiments, the method of the sixth aspect includes a step of substantially continuously rotating the fluid through a passage or borehole defined by the chamber connectors.

In embodiments, the method of the sixth aspect includes a step of substantially continuously vortexing the fluid through a passage or borehole defined by the chamber connectors.

In embodiments, the method of the sixth aspect includes a step of inducing shear force in the fluid. In embodiments, the step of inducing shear force in the fluid includes inducing shear force in the fluid in the dissolving chambers. In embodiments, the step of inducing shear force in the liquid includes inducing shear force in the fluid in the chamber connectors.

In embodiments, the method of the sixth aspect includes a step of inducing regions of negative pressure in the fluid. In embodiments, the step of inducing regions of negative pressure includes inducing regions of negative pressure in the fluid in the dissolving chambers. In embodiments, the step of inducing regions of negative pressure includes inducing regions of negative pressure in the fluid in the chamber connectors.

In embodiments, the method of the sixth aspect includes a step of inducing cavitation in the fluid. In embodiments, the step of inducing cavitation in the fluid includes inducing cavitation in the fluid in the dissolving chambers. In embodiments, the step of inducing cavitation in the fluid includes inducing cavitation in the chamber connectors.

The method of the sixth aspect may include a step of passing the fluid through an inlet chamber prior to passing the fluid through the dissolving chambers. In embodiments, the method of the sixth aspect includes as step of contracting the fluid when passing the fluid through the inlet chamber.

In embodiments, the method of the sixth aspect includes a step of rotating the fluid in the inlet chamber. In embodiments, the method of the sixth aspect includes a step of vortexing the fluid in the inlet chamber.

In embodiments, the method of the sixth aspect includes a step of passing the fluid through an outlet chamber after passing the fluid through the plurality of dissolving chambers. In embodiments, the method of the sixth aspect includes a step of expanding the fluid when passing the fluid through the outlet chamber.

In embodiments, the method of the sixth aspect includes a step of rotating the fluid in the outlet chamber. In embodiments, the method of the sixth aspect includes a step of vortexing the fluid in the outlet chamber.

In embodiments, the method of the sixth aspect includes a step of combining the gas and the liquid prior to passing the fluid comprising the gas and the liquid through the plurality of dissolving chambers.

In embodiments wherein the method of the sixth aspect includes a step of combining the gas and the liquid prior to passing the fluid comprising the gas and the liquid through the plurality of dissolving chambers, the gas and the liquid may be combined within the inlet chamber.

The method of the sixth aspect may include a step of producing or achieving an average bubble size of the gas dissolved in the liquid of less than about 1000 μm. In embodiments, the method of the sixth aspect includes a step of producing an average bubble size of the gas dissolved in the liquid of between about 1000 μm and about 1 μm.

The method of the sixth aspect may include a step of producing or achieving an average bubble size of the gas dissolved in the liquid of less than about 1000 nm. In embodiments, the method of the sixth aspect includes a step of producing an average bubble size of the gas dissolved in the liquid of between about 1000 nm and about 1 nm. In embodiments, the method of the sixth aspect includes a step of producing an average bubble size of the gas dissolved in the liquid of between about 100 nm and about 5 nm.

The method of the sixth aspect may include a step of inputting the gas and/or liquid at a pressure of at least about 1 psi. In embodiments, the method of the sixth aspect includes a step of inputting the gas and/or liquid at a pressure of between about 1 psi and about 1000 psi, including about: 2, 3, 4, 5, 6, 7, 8, 9, 10, 20, 30, 40, 50, 60, 70, 80, 90, 100, 200, 300, 400, 500, 600, 700, 800, and 900 psi.

In embodiments, the method of the sixth aspect includes a step of inputting the liquid at a pressure of between about 10 psi and about 200 psi, including about: 20, 30, 40, 50, 60, 70, 80, 90, 100, 110, 120, 130, 140, 150, 160, 170, 180, and 190 psi. In embodiments, the liquid is inputted at about 75 psi. In embodiments, the liquid is inputted at about 100 psi.

In embodiments, the method of the sixth aspect includes a step of inputting the gas at a pressure of between about 10 psi and about 200 psi, including about: 20, 30, 40, 50, 60, 70, 80, 90, 100, 110, 120, 130, 140, 150, 160, 170, 180, and 190 psi. In embodiments, the gas is inputted at about 75 psi. In embodiments, the gas is inputted at about 100 psi.

Suitably, the method of the sixth aspect includes a step of passing the fluid comprising the liquid and the gas through the plurality of dissolving chambers under a pressure differential, wherein input pressure of the liquid and/or the gas prior to the plurality of dissolving chambers is greater than output pressure of the liquid and/or gas after the plurality of dissolving chambers.

In embodiments, the pressure differential is between about 10 and about 200 psi, including about: 20, 30, 40, 50, 60, 70, 80, 90, 100, 110, 120, 130, 140, 150, 160, 170, 180, and 190 psi.

In embodiments, the pressure differential is between about 50 and about 100 psi, including about 55, 60, 65, 70, 75, 80, 85, 90, and 95 psi.

The method of the sixth aspect may be a method of dissolving the gas in the liquid using the device of the first or third aspects or the system of the fifth aspect, wherein the dissolving chambers according to the method of the sixth aspect are the dissolving chambers of the device of the first or third aspects. In embodiments, the chamber connectors according to the method of the sixth aspect are the chamber connectors of the device of the first or third aspects.

In embodiments of the method of the sixth aspect that include the step of passing the fluid through the inlet chamber prior to passing the fluid through the plurality of dissolving chambers, the inlet chamber according to the method of the sixth aspect may be the substantially conical chamber of the first end or base portion of the device of the first or third aspects.

In embodiments of the method of the sixth aspect that include the step of passing the fluid through the outlet chamber after passing the fluid through the plurality of dissolving chambers, the outlet chamber according to the method of the sixth aspect may be the substantially conical chamber of the second end or tip portion of the device of the first or third aspects.

In embodiments of the method of the sixth aspect, the liquid is or comprises water. In embodiments, the gas is selected from a hydrogen gas, an oxygen gas, and a nitrogen gas, or a combination thereof.

In an embodiment, the liquid according to the method of the sixth aspect is or comprises water, and the gas is or comprises hydrogen gas. In embodiments, the liquid is or comprises water, and the gas is or comprises oxygen gas.

In embodiments, the gas according to the method of the sixth aspect is, or is of or derived from, air. In embodiments, the gas is derived from water. The method of the sixth aspect may include a step of electrolysing water to oxygen and hydrogen gas and dissolving the oxygen and/or hydrogen gas in the liquid.

In embodiments of the method of the sixth aspect, the liquid is or comprises a hydrocarbon liquid. In embodiments, the gas is a gas for enhancing or suppressing combustion of the hydrocarbon liquid.

In embodiments, the gas for enhancing the combustion of the hydrocarbon liquid is or comprises oxygen gas and/or hydrogen gas. In embodiments, the gas for suppressing combustion of the hydrocarbon liquid is a noble gas, such as argon.

A seventh aspect of the invention provides a fluid produced according to the method of the sixth aspect, the fluid comprising a gas dissolved in a liquid.

In embodiments, the fluid of the seventh aspect comprises hydrogen gas and/or oxygen gas dissolved in water.

In embodiments, the fluid of the seventh aspect comprises a gas for enhancing or suppressing combustion dissolved in a hydrocarbon liquid.

An eighth aspect of the invention provides a method of treating or preventing a therapeutic or cosmetic condition in a subject in need thereof, the method including a step of administering the fluid of the seventh aspect to the subject.

A ninth aspect of the invention provides use of the fluid of the seventh aspect in the manufacture of a composition for therapeutic or cosmetic treatment of a subject in need thereof.

### BRIEF DESCRIPTION OF THE DRAWINGS

The invention will be described hereinafter with reference to typical embodiments illustrated in the drawings and wherein:

FIG. 1 sets forth a side perspective view of an embodiment of a device for dissolving gas in a liquid, device 10. A first type of device cap for device 10 is shown lifted in FIG. 1.

FIG. 2 sets forth a side perspective sectional view of device 10. A second type of device cap for device 10 is shown lifted in FIG. 2.

FIG. 3 sets forth a side perspective view of device 10 with additional central modules fitted. A second type of device cap for device 10 is shown fitted in FIG. 3.

FIG. 4 sets forth a side perspective sectional view of device 10 with additional central modules fitted. A second type of device cap for device 10 is shown fitted in FIG. 4.

FIG. 5 sets forth a schematic longitudinal section view of a first end module, a second end module, and a central module of device 10.

FIG. 6 sets forth a schematic longitudinal section view of device 10, showing exemplary module arrangements ‘A’ and ‘B’.

FIG. 7 sets forth a side perspective view of another embodiment of a device for dissolving gas in a liquid, device 11. A device cap for device 11 is shown fitted in FIG. 7.

FIG. 8 sets forth a side perspective sectional view of device 11. A device cap for device 11 is removed in FIG. 8.

FIG. 9 sets forth a side perspective view of another embodiment of a device for dissolving gas in a liquid, device 12.

FIG. 10 sets forth a side perspective sectional view of device 12.

FIG. 11 sets forth: (A) a front perspective view; (B) a side perspective sectional view; and (C) a side view, of a central module of device 12.

FIG. 12 sets forth a schematic longitudinal section view of another embodiment of a device for dissolving gas in a liquid, device 13. Device 13 is shown as part of an inline system, system 5.

FIG. 13 sets forth a 3D model of internal space within an embodiment of device 12.

FIG. 14 sets forth (A) a mesh view for a 3D model for analysis of fluid flow within a region of a dissolving chamber of device 12; and (B) a close-up of scale for the 3D model.

FIG. 15 sets forth velocity streamlines modelled within the internal space of device 12.

FIG. 16 sets forth Q criterion modelled within the internal space of device 12.

FIG. 17 sets forth velocity vectors modelled within the internal space of device 12.

FIG. 18 sets forth (A) a magnified view of velocity vectors modelled within a region of a dissolving chamber of device 12; (B) a close-up of scale for the velocity vector modelling.

FIG. 19 sets forth absolute pressure modelled within the internal space of device 12.

FIG. 20 sets forth cavitation formation modelled within the internal space of device 12.

FIG. 21 sets forth critical bubble diameter modelled within the internal space of device 12.

FIGS. 22 and 23 set forth relative dimensions of dissolving chambers and connecting channels of device 12.

### DETAILED DESCRIPTION OF EMBODIMENTS

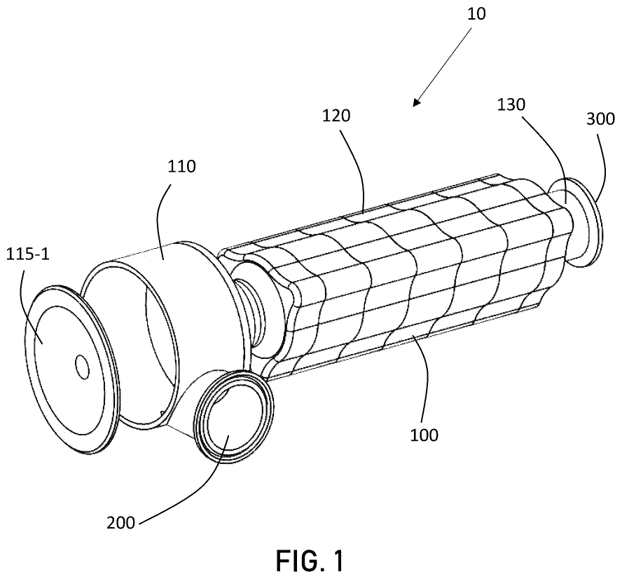

FIGS. 1-12 show embodiments of a device according to an aspect of the invention, the device being adapted for dissolving gas in liquid. The device is at times referred to herein as a ‘gas dissolving device’.

FIGS. 1-4 show a first embodiment of the gas dissolving device of the invention, device 10. Device 10 comprises device body 100; liquid inlet 200; and liquid outlet 300.

Device body 100 of device 10 comprises base portion 110; central portion 120; and tip portion 130. Device body 100 of device 10 is a modular device body, as further described herein.

Liquid inlet 200 is of base portion 110 of device body 100. Liquid outlet 300 is of tip portion 130 of device body 100.

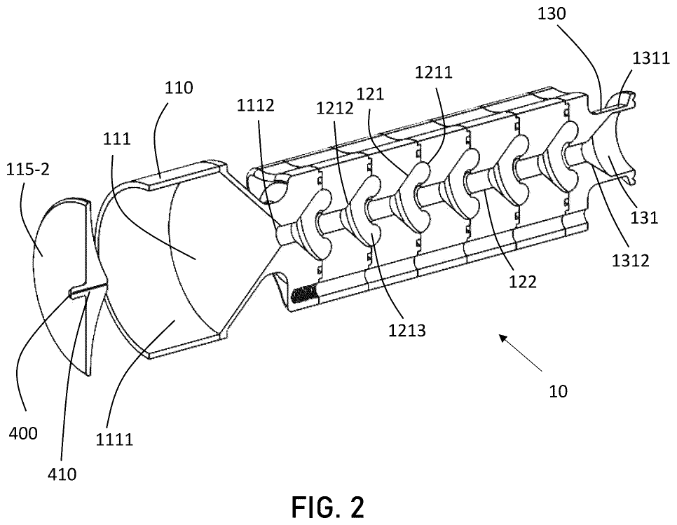

As seen in FIG. 2 and FIG. 4, base portion 110 of device body 100 comprises substantially conical chamber 111, conical chamber 111 comprising wider first end 1111; and narrower second end 1112. Liquid inlet 200 of device 100 extends laterally from wider first end 1111 of conical chamber 111.

Base portion 110 of device body 100 further comprises, or is connectable with, base portion cap 115.

A first base portion cap 115-1 is shown in FIG. 1. First base portion cap 115-1 is a substantially convex cap that can be sealingly fitted with base portion 110 closing wider first end 1111.

A second base portion cap 115-2 is shown in FIG. 2. Second base portion cap 115-2 comprises gas inlet 400. Second base portion cap 115-2 can be fitted with base portion 110 closing wider first end 1111 with the exception of gas inlet 400. Base portion cap 115-2 protrudes centrally, extending gas inlet passage 410 of gas inlet 400.

Tip portion 130 of device body 100 comprises substantially conical chamber 131 comprising wider first end 1311; and narrower second end 1312. Liquid outlet 300 of device 100 extends linearly from wider end 1311 of conical chamber 131 as a nozzle of device 10.

Central portion 120 of device body 100 comprises substantially conical chambers 121, each conical chamber 121 comprising wider first end 1211; and narrower second end 1212. Chambers 121 are at times referred to herein as ‘dissolving chambers’. Wider first end 1211 of each conical chamber 121 comprises rounded outer region 1213. Conical chambers 121 are of heart-like shape in longitudinal section. More particularly, wider first end 1211 comprising rounded outer region 1213 is a toroidal end, such that conical chambers 121 of central portion 120 of device body 100 may be described as conical, toroidal chambers.

Respective narrowed inlet/outlet channels 122 extend from conical chamber 111 of base portion 110 to conical chamber 131 of tip portion 130, via each conical chamber 121 of central portion 120. Inlet/outlet channels 122 are at times referred to herein as ‘connecting channels’. It will be understood that channels 122 may be considered part of, or connected with, dissolving chambers 121 within central portion 120 of device body 100.

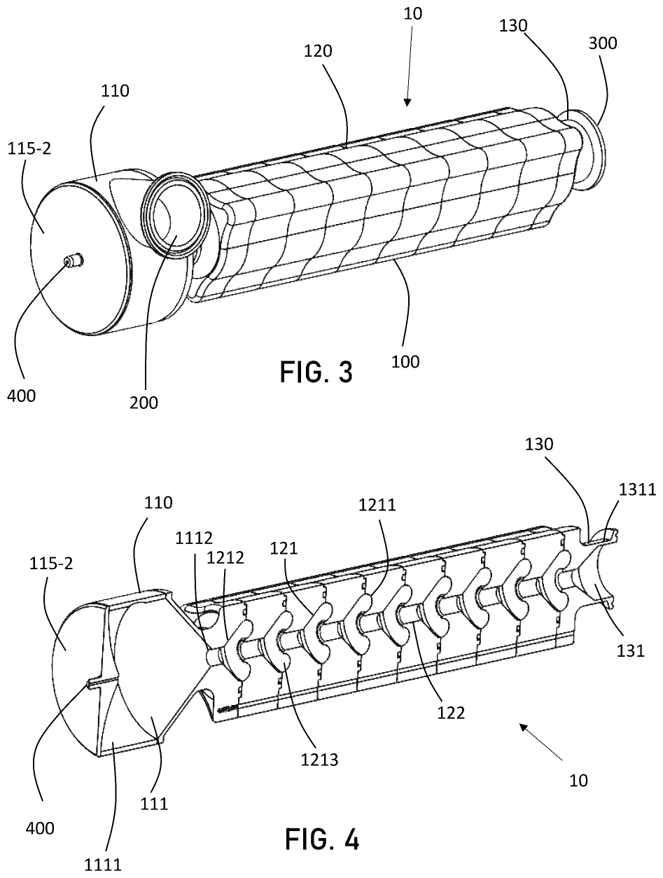

The embodiment of device 10 depicted in FIG. 1 and FIG. 2 comprises six conical, toroidal chambers 121; and seven connecting channels 122. The embodiment of device 10 depicted in FIG. 3 and FIG. 4 comprises nine conical, toroidal chambers 121; and ten connecting channels 122.

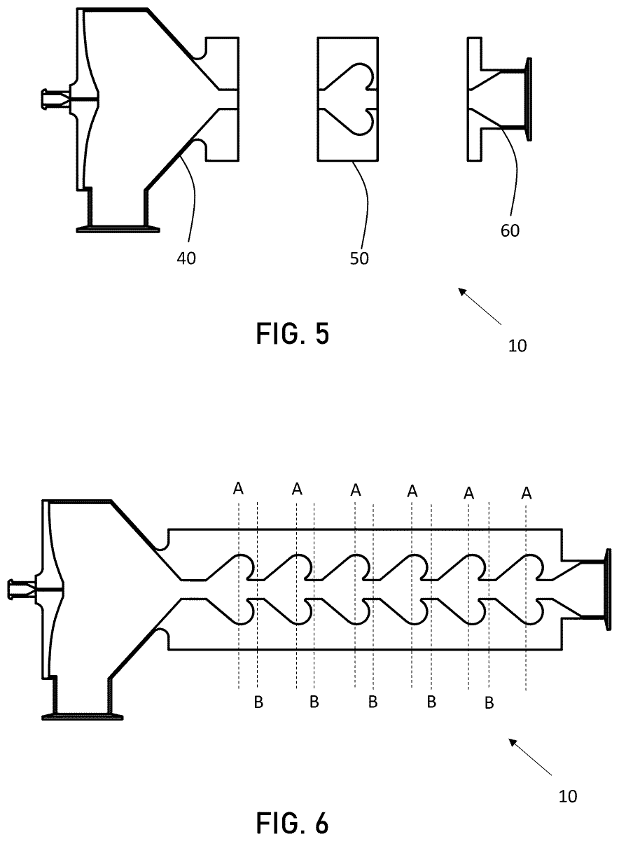

As schematically depicted in FIG. 5 and FIG. 6, device body 100 of device 10 is separatable into modules. The modules of device body 100 of device 10 comprise first end module 40; second end module 60; and central module 50. Typically, device 10 comprises a plurality of central modules 50. Modules 40, 50, and 60 of device body 100 are typically connectable using seals (e.g. O-rings) and fasteners (e.g. bolts) and/or threads. In some embodiments, chemical sealant may be additionally or alternatively used for connection of modules 40, 50, and/or 60.

It will be understood that the particular manner in which device 10 is separated into first end module 40; second end module 60; and central module 50 can be varied. By way of non-limiting example, FIG. 6 illustrates (with respective series of dashed lines labelled ‘A’ and ‘B’, respectively), two typical divisions of a six-conical chamber 121 device 10 into first end module 40; second end module 60; and central module 50.

In the module arrangement illustrated by the ‘A’ series of dashed lines, first end module 40 of device 10 comprises base portion 110 of device body 100; and a part of central portion 120 of device body 100 comprising a connecting channel 122 and a part of the conical chamber 121 nearest base portion 110.

In the ‘A’ series module arrangement of device 10, each of five central modules 50 comprise a part of central portion 120 of device body 100 comprising a connecting channel 122 and a part of two adjacent conical chambers 121.

In the ‘A’ series module arrangement of device 10, second end module 60 comprises tip portion 130 of device body 100; and a part of central portion 120 of device body 100 comprising a connecting channel 122 and a part of the conical chamber 121 nearest tip portion 130.

In the module arrangement illustrated by the ‘B’ series of dashed lines, first end module 40 comprises base portion 110 of device body 100; a connecting channel 122; and a part of central portion 120 of device body 100 comprising the conical chamber 121 nearest base portion 110.

In the ‘B’ series module arrangement of device 10, each central module 50 comprises a part of central portion 120 of device body 100 comprising a part of two adjacent connecting channels 122 and one of the conical chambers 121.

In the ‘B’ series module arrangement of device 10, second end module 60 comprises tip portion 130 of device body 100; and a part of central portion 120 of device body 100 comprising a part of two adjacent connecting channels 122 and the conical chamber 121 nearest tip portion 130.

It will be readily appreciated that the schematic depiction in FIG. 6 is non-limiting and that various other modular arrangements may be used.

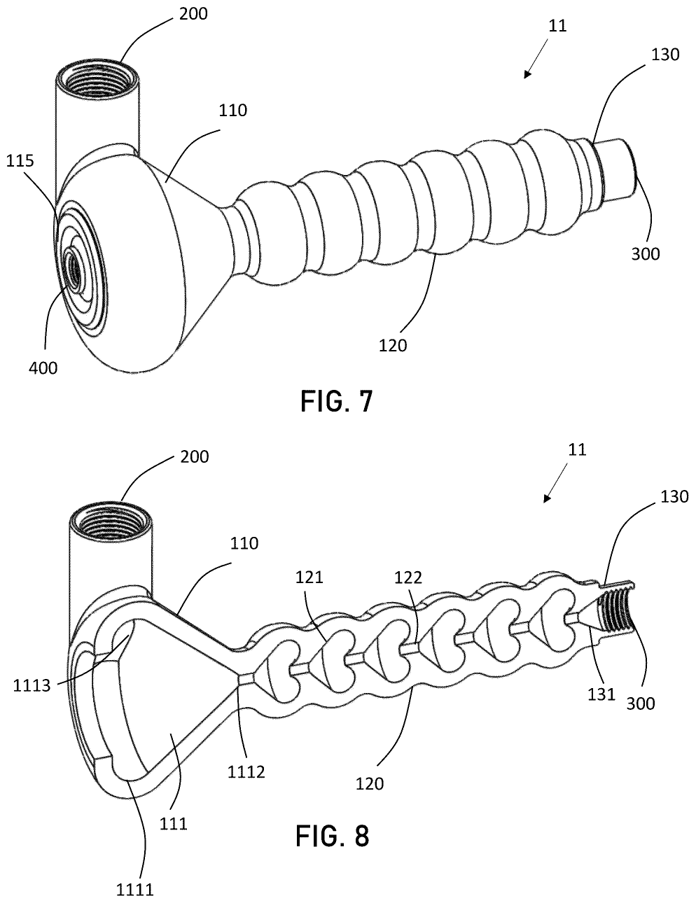

FIG. 7 and FIG. 8 show another embodiment of a device of the invention, device 11. Similarly to device 10, device 11 comprises device body 100; liquid inlet 200; and liquid outlet 300.

In contrast to that of device 10, device body 100 of device 11 is a unitary body, wherein base portion 110; central portion 120; and tip portion 130 of body 100 are formed as a single unit. Certain other notable features of device 11 are described as follows.

As for device 10, base portion 110 of device 11 comprises conical chamber 111, conical chamber 111 comprising wider first end 1111; and narrower second end 1112. Conical chamber 111 of base portion 110 of device 11 further comprises rounded outer region 1113, such that conical chamber 111 of base portion 110 of device 11 is of heart-like shape in longitudinal section. More particularly, conical chamber 111 of device 12 may be considered a conical, toroidal chamber.

Liquid inlet 200 of device 11 is a threaded liquid inlet. Liquid outlet 300 of device 11 is a threaded liquid outlet.

Device 11 comprises disc-like base portion cap 115. Similarly to second base portion cap 115-2 of device 10, base portion cap 115 of device 11 comprises gas inlet 400. Gas inlet 400 of device 11 is a threaded, circular gas inlet of a larger diameter relative to base portion 110 as compared to gas inlet 400 of second base portion cap 115-2 of device 10.

Also similarly to second base portion cap 115-2 of device 10, base portion cap 115 of device 11 protrudes centrally extending gas inlet passage 410 of gas inlet 400. It will be understood that the centrally protruding structure of base portion cap 115 of device 11 contributes to the toroidal structure of chamber 111 of device 11, when base portion cap 115 is fitted.

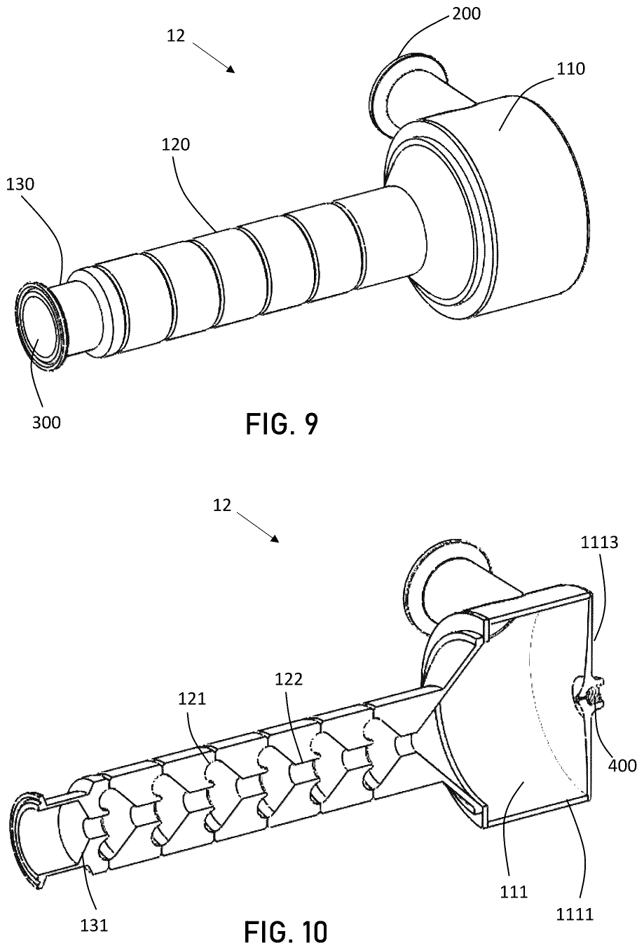

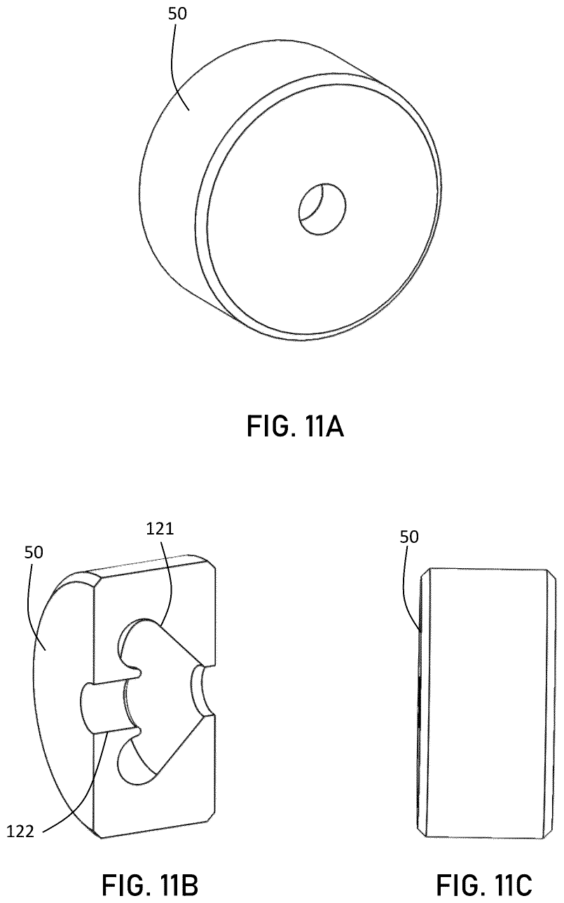

FIG. 9 and FIG. 10 show another embodiment of a device of the invention, device 12.

Device 12 comprises very similar components as those of device 10, including modular device body 100; liquid inlet 200; liquid outlet 300; and gas inlet 400.

The shape of device body 100 of device 12, and particularly central modules 50 thereof, differs from that of device 10. As shown in detail in FIG. 11, central modules 50 are substantially disc-like central modules.

It will be further appreciated that, as depicted in FIG. 9 and FIG. 10, device 12 comprise a fixed floor 1113 in place of removable base portion cap 115. However, it will be understood that device 12 may alternatively comprise a base portion cap, such as a base portion cap similar to first base portion cap 115-1 or second base portion cap 115-2.

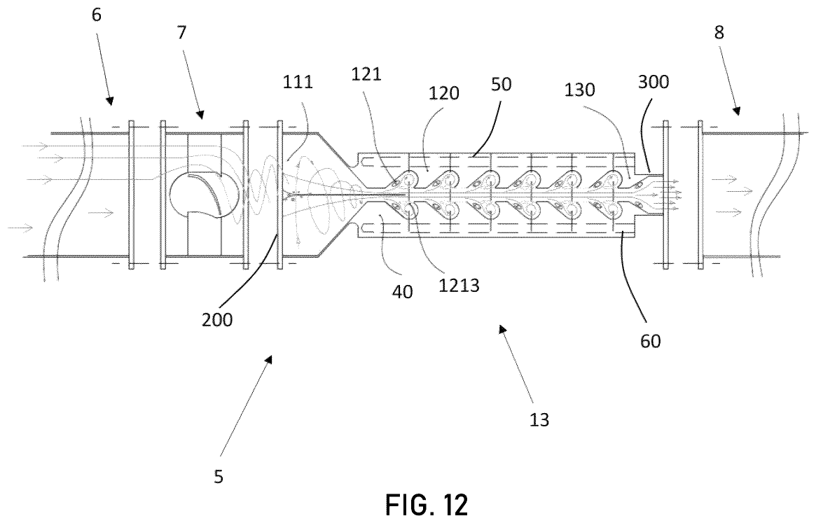

In FIG. 12, a further embodiment of a device of the invention, device 13, is shown as part of an inline system for dissolving gas in a liquid, system 5.

Device 13 is similar to device 10, however, no base portion cap 115 is fitted to device 13, such that wider end 1111 of substantially conical chamber 111 is open. Furthermore, inlet 200 of device 13 takes the form of open wider end 1111, rather than a laterally extending inlet as for devices 10-12.

In addition to device 13, system 5 comprises inlet pipe 6, impellor 7, and outlet pipe 8. Impellor 7 is typically in the form of a stationary multi-blade impellor as are known in the art.

Inlet pipe 6 and impellor 7 of system 5 are connected with inlet 200 of device 13, in the form of open wider end 1111 of conical chamber 111 of base portion 110.

Outlet pipe 8 of system 5 is connected with liquid outlet 300 of device 13.

Devices 10-13 as described herein may be formed using any suitable materials.

Typically, devices 10-13 are formed at least primarily from metallic materials, such as stainless steel, titanium, and/or aluminium. Metal and/or semi-metal (e.g. carbon) composites may also be suitable or desirable. Embodiments of device 10-12 may in some instances be formed using plastic materials, such as polyvinyl chloride (PVC) or polyethylene (PE). Generally, properties of relatively high strength, durability, and rust resistance are typically desirable for devices 10-13, and materials can be used accordingly. Relatively lightweight construction may be desirable in some instances.

It will be appreciated that the particular materials chosen for manufacture of devices 10-13 may relate to or be influence by the size or scale of the device. As herein described, devices 10-13 have a vast range of potential applications, and the size of a particular device will generally be determined, at least in part, by the application or applications for which it is designed.

For certain therapeutic uses, the device may be sized to output millilitres of liquid per second and/or litres of liquid per minute. For agricultural or industrial applications, substantially larger devices may be used, such as for outputting litres or greater of liquid per second. Of course, it will be understood that the output from devices 10-13 will typically also be influenced by factors other than device size, such as the pressure at which the liquid and/or the gas is directed into devices 10-13.

Typical use of devices as described herein will now be described.

In use, liquid is directed into inlet 200 of devices 10-13.

In embodiments of devices as described herein that do not comprise gas inlet 400, such as device 10 and device 13, the liquid directed into liquid inlet 200 comprises a gas to be concentrated in the liquid dissolved therein.

In embodiments of devices as described herein that comprise gas inlet 400, the liquid directed into liquid inlet 200 may or may not include a substantial amount of a gas to be concentrated in the liquid dissolved therein. In either case, in use, the gas to be concentrated in the liquid is directed into gas inlet 400, wherein the gas combines with the liquid in conical chamber 111 of base portion 110 of device body 100.

In use, fluid comprising the liquid and the gas to be concentrated therein vortexes within conical chamber 111, contracting while passing to the conical chamber 121 of central portion 120 that is nearest base portion 110 via the respective connecting channel 122.

For devices 10-12, vortexing within conical chamber 111 is facilitated by directing the liquid laterally into the chamber via inlet 200. For device 13, vortexing of the liquid is typically commenced prior to entry into inlet 200, such as by passage of the liquid through impellor 7 of system 5.

In use, when the fluid comprising the liquid and the gas enters conical chamber 121 of devices 10-13, the vortexing fluid expands. The vortexing fluid is then subjected to compression force when passing towards the next conical chamber towards the liquid outlet via the respective connecting channel 122.

In use, passage of the vortexing fluid through each conical chamber 121 and connecting channel 122 creates pressure differences and turbulence, as described in further detail hereinbelow. The pressure differences and turbulence results in substantial shear force within the fluid. Furthermore, as described in further detail hereinbelow, substantial cavitation of the fluid occurs due to formation of regions of negative pressure, the cavitation occurring primarily within connecting channels 122.

In use, shear force and cavitation reduces bubble size of dissolved gas in the fluid. With reference to the examples hereinbelow, and without being bound by theory, cavitation, in particular, is understood by the applicant to be important for production of nanobubbles.

In use, as the fluid passes between each of the conical chambers 121, the shear force and cavitation, and associated reduction of gas bubble size and dissolving of the gas within the liquid, repeats. This is understood by the applicant to result in an increasing concentration of gas dissolved within the liquid, and a decreasing average bubble size of gas dissolved in the liquid, as the fluid passes between each of the respective conical chambers 121.

In use, after passing through all of the conical chambers 121 of central portion 120 of device body 100, the fluid goes through a final expansion within conical chamber 131 of tip portion 130. The liquid containing the gas concentrated therein is then directed out of outlet 300.

It will be readily appreciated that any suitable fitting can be attached to liquid inlet 200, liquid outlet 300, and gas inlet 400 of gas dissolving devices described herein. Typically, respective pipes or hoses are attached to liquid inlet 200, liquid outlet 300, and gas inlet 400. Attachment of pipes is exemplified in system 5. It will be appreciated that similar arrangements can be employed using devices 10-12.

In use, the liquid and/or the gas may be directed into devices 10-13 at any suitable pressure. It will be appreciated that liquid and/or gas may be directed into device 10-13 under positive pressure or negative pressure.

The liquid and/or the gas may be directed into devices 10-13 at pressure of between about 1 and about 1000 pounds per square inch (psi), including about: 2, 3, 4, 5, 6, 7, 8, 9, 10, 20, 30, 40, 50, 100, 150, 200, 250, 300, 350, 400, 450, 500, 600, 700, 800, and 900 psi.

Typically, the liquid and/or the gas is directed into devices 10-13 at a pressure of between about 10 psi and about 200 psi, including about: 20, 30, 40, 50, 60, 70, 80, 90, 100, 110, 120, 130, 140, 150, 160, 170, 180, and 190 psi. In some typical embodiments, the liquid and/or the gas is directed into devices 10-13 at about 75 psi, about 85 psi, about 90 psi, about 100 psi, about 120 psi, about 130 psi, or about 140 psi. In some typical embodiments, the liquid and/or the gas is directed into devices 10-13 at about 75 psi or about 85 psi. In some typical embodiments, the liquid is directed into devices 10-13 at about 100 psi.

It will be understood that, in typical use, the fluid, including the liquid and/or gas, passes between the inlet and the outlet of the device under a pressure differential between pressure at the inlet and pressure at the outlet, wherein pressure at the inlet is greater than pressure at the outlet.

Typically, the pressure differential is between about 10 and about 200 psi, including about: 20, 30, 40, 50, 60, 70, 80, 90, 100, 110, 120, 130, 140, 150, 160, 170, 180, and 190 psi. More typically, the pressure differential is between about 50 and about 100 psi, including about 55, 60, 65, 70, 75, 80, 85, 90, and 95 psi.

It will be appreciated that, generally, device embodiments of larger scale may be used with larger pressure differentials, although without limitation thereto.

Any suitable equipment may be used to facilitate passage of fluid through devices 10-13. In embodiments, one or more pumps or pumping systems are used to passage fluid through device 10-13 under pressure. It will be readily appreciated by the skilled person that positive pressure pumping into the device inlet and/or negative pressure pumping out of the device outlet can be used to passage fluid, including liquid and/or gas, through devices 10-13 under pressure.

The skilled person will understand that the liquid as described herein will have an atmospheric saturation point for the gas, representing the highest concentration of the gas that will stably dissolve in the liquid when exposed to standard atmospheric conditions. In some typical embodiments, the liquid directed out of outlet 300 comprises a concentration of at least about: 50%, 55%, 60%, 65%, 70%, 75%, 80%, 85%, 90%, 95%, or 100% of that of the atmospheric saturation point. More typically, the liquid directed out of outlet 300 comprises a concentration of at least about: 90%, 95%, or 100% of that of the atmospheric saturation point.

In some typical embodiments, the liquid directed out of outlet 300 is saturated or substantially saturated with the gas, comprising a concentration of about 100% of that of the atmospheric saturation point.

In some embodiments, the liquid directed out of outlet 300 is ‘super saturated’ with the gas relative to the atmospheric saturation point, containing a higher concentration of the gas than that of the atmospheric saturation point.

In embodiments, the super saturated liquid directed out of outlet 300 comprises a concentration of at least about: 105%, 110%, 115%, 120%, 125%, 130%, 135%, 140%, 145%, 150%, 155%, 160%, 165%, 170%, 175%, 180%, 185%, 190%, 195%, or 200% of that of the atmospheric saturation point.

In embodiments, the super saturated liquid directed out of outlet 300 comprises a concentration of at least about: 200%, 300%, 400%, 500%, 600%, 700%, 800%, 900%, or 1000% of that of the atmospheric saturation point.

In embodiments, the super saturated liquid directed out of outlet 300 comprises a concentration of at least about: 2000%, 3000%, 4000%, 5000%, 6000%, 7000%, 8000%, 9000%, or 10,000% of that of the atmospheric saturation point.

It will be understood by the skilled person that the atmospheric saturation point can vary substantially depending on the particular gas and the particular liquid. For example, at standard temperature and pressure, the atmospheric saturation point of hydrogen gas (H₂) in water is about 1.6 parts per million (ppm), whereas the atmospheric saturation point of oxygen gas (O₂) in water is about 14.6 ppm. It will be further appreciated by the skilled person that saturation point varies depending on temperature and pressure conditions.

With the preceding in mind, the concentration of the gas dissolved in the liquid directed out of outlet 300 may be between about 1 part per billion (ppb) and about 1%.

In embodiments, the concentration of the gas dissolved in the liquid directed out of outlet 300 may be about: 1, 10, 20, 30, 40, 50, 60, 70, 80, 90, 100, 200, 300, 400, 500, 600, 700, 800, 900, or 1000 ppb.

In embodiments, the concentration of the gas dissolved in the liquid directed out of outlet 300 may be about 1, 10, 20, 30, 40, 50, 60, 70, 80, 90, 100, 200, 300, 400, 500, 600, 700, 800, 900, or 1000 ppm.

In embodiments, the concentration of the gas dissolved in the liquid directed out of outlet 300 may be about 0.1, 0.2, 0.3, 0.4, 0.5, 0.6, 0.7, 0.8, 0.9, or 1%.

As herein described, devices 10-13 can be highly effective for producing dissolved gas bubbles of very small average size. Average bubble size of the dissolved gas in the nanometre range is typically achievable using devices as described herein. Nanometre size dissolved gas bubbles are at times referred to herein as ‘nanobubbles’.

It is understood by the applicant that decreasing average bubble size of dissolved gas in liquid produced by devices as described herein can increase stability of the dissolved gas in the liquid, maintaining comparatively high concentrations of dissolved has for relatively extended periods of time. In particular, it is understood by the applicant that dissolved nanobubbles produced by devices 10-13 are desirable for increasing stability of the dissolved gas in the liquid.

With the preceding in mind, in some embodiments, in use, the liquid directed out of outlet 300 may comprise bubbles of the gas dissolved therein of an average size of between about 1 micrometre (μm) to about 1000 μm, including about: 2, 3, 4, 5, 6, 7, 8, 9, 10, 20, 30, 40, 50, 60, 70, 80, 90, 100, 200, 300, 400, 500, 600, 700, 800, and 900 μm.

In some typical embodiments, in use, the liquid directed out of outlet 300 may comprise bubbles of the gas dissolved therein of an average size of between about 1 nanometre (nm) to about 1000 nm, including about: 2, 3, 4, 5, 6, 7, 8, 9, 10, 20, 30, 40, 50, 60, 70, 80, 90, 100, 200, 300, 400, 500, 600, 700, 800, and 900 nm.

In some typical embodiments, in use, the liquid directed out of outlet 300 may comprise bubbles of the gas dissolved therein of an average size of between about 5 nm to about 100 nm, including about: 6, 7, 8, 9, 10, 15, 20, 25, 30, 35, 40, 45, 50, 55, 60, 65, 70, 75, 80, 85, 90, and 95 nm.

In some embodiments, in use, the liquid directed out of outlet 300 may comprise bubbles of the gas dissolved therein of an average size of between about: 100 (picometre) pm to about 1000 pm, including about 200, 300, 400, 500, 600, 700, 800, and 900 pm.

It will be appreciated that concentration of the gas dissolved in the liquid and/or the average bubble size of the gas dissolved in the liquid directed out of outlet 300 may be adjusted or controlled by modifying various parameters of devices 10-13 and/or use thereof.

Without being bound by theory, the applicant believes that increasing the number of conical chambers 121 of central portion 120 of devices 10-13 may allow for the concentration of the gas dissolved in the liquid to be increased, under at least some circumstances.

Without being bound by theory, the applicant believes that increasing the number of conical chambers 121 of central portion 120 may allow for the average bubble size of the gas dissolved in the liquid to be decreased, under at least some circumstances.

Without being bound by theory, the applicant believes that narrowing inlet/outlet channels 122 of devices 10-13, such as narrowing inlet/outlet channels 122 relative to one or more other dimensions of devices 10-13, may allow for the concentration of the gas dissolved in the liquid to be increased, under at least some circumstances.

Without being bound by theory, the applicant believes that narrowing inlet/outlet channels 122, such as narrowing inlet/outlet channels 122 relative to one or more other dimensions of devices 10-13, may allow for the average bubble size of the gas dissolved in the liquid to be decreased, under at least some circumstances.

Without being bound by theory, the applicant believes that modifying, such as increasing, the pressure (or the negative pressure, i.e. suction) directing the fluid, including the liquid and/or gas, into devices 10-13 may allow for the concentration of the gas dissolved in the liquid to be increased, under at least some circumstances.

Without being bound by theory, the applicant believes that modifying, such as increasing, the pressure differential under which the fluid, including the liquid and/or gas, passes through device 10-13 may allow for the concentration of the gas dissolved in the liquid to be increased, under at least some circumstances.

Without being bound by theory, the applicant believes that modifying, such as increasing, the pressure or the negative pressure directing the liquid and/or gas into devices 10-13 may allow for the average bubble size of the gas dissolved in the liquid to be decreased, under at least some circumstances.

Without being bound by theory, the applicant believes that modifying, such as increasing, the pressure differential under which the fluid, including the liquid and/or gas, passes through device 10-13 may allow for the average bubble size of the gas dissolved in the liquid to be decreased, under at least some circumstances.

It will be appreciated that modular devices as described herein, such as devices 10, 12, and 13 can allow for the number of conical chambers 121 of body 100 to be adjusted, by adding or removing one or more central modules 50. This may be advantageous for modifying the concentration of the gas dissolved in the liquid and/or the average bubble size of the gas dissolved in the liquid.

The modular structure of devices 10, 12, and 13 can also be advantageous for sanitisation and/sterilisation purposes. For example, modular devices 10, 12, and 13 can be separated into modules 40, 50, and 60 for autoclaving or the like. This may be particularly advantageous wherein devices 10, 11, and 13 are used in a therapeutic context.

Although unitary devices as described herein, such as device 11, are typically not designed for exchange of modules as are devices 10, 12, and 13, it will be appreciated that the concentration of the gas dissolved in the liquid and/or the average bubble size of the gas dissolved in the liquid may nevertheless be modifiable such as by adjusting the fluid pressure or pressure differential as hereinabove described.

It will be appreciated that the unitary structure of device 11 may be advantageous for facilitating manufacture of device 11 as a unit, such as by 3D printing manufacturing approaches and the like. Such approaches may be advantageous for disposable or temporary devices, and/or for devices manufactured with relatively small dimensions, although without limitation thereto.

The liquid in which the gas is dissolved using devices 10-13 may be any suitable liquid.

In some typical embodiments, the liquid is an aqueous liquid. In some typical embodiments, the liquid is water such as substantially pure water.

In some typical embodiments, the liquid is an aqueous biological or biologically active liquid, or a synthetic form thereof. The aqueous biological or biologically active liquid may be a biofluid, or a synthetic form thereof, such as blood, serum, or interstitial fluid.

In some typical embodiments, the liquid is an organic liquid (i.e. a liquid comprising one or more organic compounds). The organic liquid may be a biological or biologically active organic liquid, or a synthetic form thereof. The organic liquid may be a food additive or food preservative.

In some typical embodiments, the liquid is a hydrocarbon liquid. In some typical embodiments, the liquid is a hydrocarbon liquid fuel, such as a petroleum or diesel.

The liquid may be or comprise a non-aqueous inorganic liquid, or a liquid metal or liquid metallic alloy. The non-aqueous inorganic liquid may be or comprise ammonia, sulphuric acid, hydrogen fluoride, antimony trichloride, or bromine pentafluoride, although without limitation thereto. The liquid metal/metal alloy may be or comprise mercury, caesium, gallium, rubidium, or lithium, although without limitation thereto.

The applicant considers that there may be application within fields such as nuclear and/or refrigeration technology (although without limitation thereto) for devices and methods as described herein, optimised for dissolving of gas in non-aqueous inorganic liquids and liquid metals such as those exemplified above.

The gas dissolved in the liquid using devices 10-13 may be any suitable gas.

In some embodiments, the gas is an elemental gas, inclusive of hydrogen elemental gas (H₂), nitrogen elemental gas (N), oxygen elemental gas (O₂), fluorine elemental gas F₂), chlorine elemental gas (C₂), helium elemental gas (He), neon elemental gas (Ne), argon elemental gas (Ar), krypton elemental gas (Kr), xenon elemental gas (Xe), and radon elemental gas (Rn).

In some embodiments, the gas is a multielement gas, inclusive of carbon dioxide (CO₂), sulfur dioxide (SO₂), hydrogen chloride (HCl), ammonia (NH₃), and carbon monoxide (CO).

In some embodiments, the gas is a hydrocarbon gas, inclusive of methane (CH₄), ethane (C₂H₆), propane (C₃H₈), butane (C₄H₁₀), pentane (C₅H₁₂), hexane (C₆H₁₄), heptane (C₇H₁₆), and octane (C₈H₁₈).

In some typical embodiments, the liquid in which the gas is dissolved using devices 10-13 is or comprises water, and the gas dissolved in the liquid is or comprises hydrogen gas (H₂).

In some typical embodiments, the liquid in which the gas is dissolved using devices 10-13 is or comprises water, and the gas dissolved in the liquid is or comprises oxygen gas (O₂).

In some typical embodiments, the liquid in which the gas is dissolved using devices 10-13 is or comprises water, and the gas dissolved in the liquid is or comprises hydrogen gas and oxygen gas.

In typical embodiments wherein the liquid is or comprises water and the gas dissolved in the liquid is or comprises hydrogen gas, oxygen gas, or a combination of hydrogen gas and oxygen gas, the liquid comprising (typically substantially saturated or super-saturated with) the gas may be highly desirable for a range of applications.

By way of non-limiting example, the liquid may be desirable for a large number of therapeutic and/or cosmetic applications for the treatment of humans and other animals. The liquid may be desirable for agricultural applications including for stimulating plant or animal health and/or productivity. The liquid may be desirable for environmental remediation.

In the particular case of aqueous liquids comprising both oxygen gas and hydrogen gas, the antioxidant activity of the hydrogen gas may limit or offset oxygen toxicity effects in a biological context. This may allow for higher concentrations of oxygen to be applied or deployed in biological contexts than might be suitable using oxygen alone.

In some typical embodiments, the liquid in which the gas is dissolved using devices 10-13 is or comprises a diesel hydrocarbon fuel, and the gas dissolved in the liquid is or comprises hydrogen and/or oxygen. Diesel hydrocarbon fuel comprising oxygen and/or hydrogen gas may have enhanced combustion properties, which may be desirable for fuel efficiency or the like.

In some typical embodiments, the liquid in which the gas is dissolved using devices 10-13 is or comprises a gasoline hydrocarbon fuel, and the gas dissolved in the liquid is or comprises argon. Gasoline hydrocarbon fuel comprising argon may have enhanced stability properties, which may be desirable for storage or shipping or the like.

In embodiments as described herein wherein oxygen gas is dissolved in the liquid, it may be convenient or otherwise desirable to obtain the oxygen gas from air for dissolving in the liquid, such as by drawing air into gas inlet 400.

In embodiments as described herein wherein oxygen and/or hydrogen has is dissolved in the liquid, it may be convenient or otherwise desirable to obtain the oxygen and/or hydrogen gas by electrolysis of water. It will be understood that devices 10-13 may be used in conjunction with or as part of a system comprising electrolysis equipment.

### EXAMPLES

### Example 1

The following example details experimental assessment of gas bubble size achieved using embodiments of a gas dissolving device according to the invention.

### Background

Initial experimental assessment of the gas dissolving device was performed using embodiments of the device comprising a liquid inlet that directed fluid into the device in the absence of substantial vortexing. Subsequent assessment was performed using embodiments of the device wherein vortexing fluid was received via the inlet, either by creating vortexing with the structure of the device itself, or by directing vortexing fluid into the inlet. In general, the gas dissolving device was observed to be highly effective for dissolving of hydrogen gas in water, with vortexing of fluid via the inlet observed to improve performance.

The size of dissolved gas bubbles achieved was understood by the applicant to be a key factor in the effectiveness of the device, particularly in relation to stability of the dissolved gas. Accordingly, experimental assessment of bubble size was performed.

### Materials and Methods

A Microtrac NANO-flex device (https://www.labwrench.com/equipment/16976/microtrac-nano-flex) was used for bubble size assessment in accordance with manufacturer recommendations.

In initial experiments, a six dissolving chamber embodiment of the gas dissolving device was fitted to a submersible pump, the pump and device immersed in 900 L of water, and hydrogen gas directed into the pump and device under negative pressure. After two minutes running time, a sample of water was taken and allowed to sit for 30 seconds, before bubble size was measured. Sub-micrometre bubble size was observed in initial experiments.

In subsequent experiments, effect of inlet pressure and inlet vortexing was explored. For this purpose, a test rig comprising a water tank, an external pump with adapters for connection of the gas dissolving device, and a hydrogen gas source (typically the HYDRO-QUBE QB5 model, manufactured by Hydrogen Technologies https://hydrogentechnologies.com.au/product/hydro-qube-qb5/) was used. Fluid output from the device comprising water and dissolved hydrogen was assessed for dissolved gas bubble size using the Microtrac NANO-flex.

For six dissolving chamber embodiments of the device, in the absence of vortexing, inlet pressure of 75 psi consistently achieved average dissolved gas bubble size well below 500 nm. With the addition of vortexing, average dissolved gas bubble size of well below 100 nm was achieved. In one experiment using inlet pressure of 100 psi and inlet vortexing with an embodiment of the device substantially as described for device 12 herein, with reference to FIG. 9 and FIG. 10, average bubble size of less than 10 nM was observed.

### DISCUSSION

Extensive experimentation revealed that embodiments of the gas dissolving device are capable of achieving high concentrations of dissolved hydrogen has in water with average bubble size in the nanobubble range. With inlet pressure of 75 psi and inlet vortexing, average bubble size of below 100 nm was achieved with six dissolving chamber embodiments of the device. In one experiment with inlet pressure 100 psi and inlet vortexing, average bubble size of less than 10 nM was observed

Experimentation has revealed that inlet pressure and inlet vortexing are significant factors in minimising dissolved gas bubble size. Dissolving chamber number may well be another significant factor in influencing dissolved gas bubble size and/or concentration of dissolved gas. The specific relationship between dissolving chamber number and gas bubble size is being further investigated in ongoing experimentation.

### Conclusion

Experimental results revealed the ability of the gas dissolving device to produce high concentrations of extremely small dissolved gas bubbles with inlet pressure of 75-100 psi and inlet vortexing—consistently under 100 nm and potentially as low as under 10 nm. The extremely small bubble size achieved by the device is understood to allow dissolved gas to remain in fluid, such as water, for extended periods of time.

### Example 2

The following example details Computational Fluid Dynamics (CFD) analysis conducted for the gas dissolving device.

A key objective of this analysis was to simulate the flow field and turbulence in the gas dissolving device, to ascertain the minimum gas bubble size to be expected based on turbulence effects. This information was then compared to minimum gas bubble size experimentally achieved by the gas dissolving device, and further factors that may be contributing to bubble breakup were explored.

### Modelling Approach

### Software

The CFD simulations were conducted using Fluent 2022 R2. Ansys Fluent, part of the Ansys Suite of software, is a CFD code that solves the Reynolds Averaged Navier-Stokes (RANS) Equation using hybrid grids with second-order numerics. Ansys software development and testing are ISO 9001 compliant with verification and validation manuals available (X. Wang, Y. Shuai, H. Zhang, J. Sun and Y. Yang et al, “Bubble breakup in a swirl-venturi microbubble generator,” Chemical Engineering Journal 403, 2021) in addition to Ansys Quality Assurance Services (ANSYS Inc, “ANSYS Quality Assurance,” [Online]. Available: https://www.ansys.com/about-ansys/quality-assurance).

### Geometry

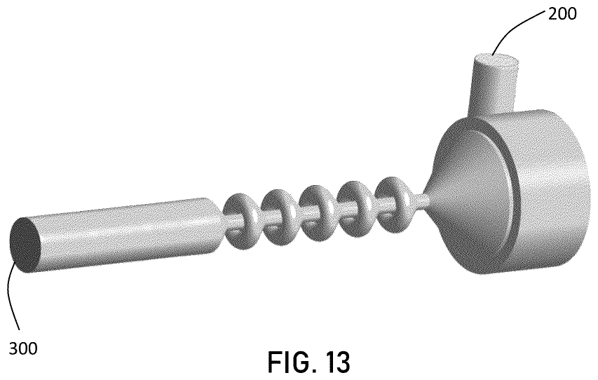

A 3D CAD model of the internal space of the gas dissolving device was produced. The model is shown in FIG. 13. With reference to FIG. 13, flow enters at the inlet on the right and travels through to the outlet on the left. For the purposes of the CFD analysis, the geometry of the model was extended at the outlet region to improve the capture of the flow field by the CFD solver in the exit expansion region.

### Model Description

### Model Setup

Operating conditions were set at inlet gauge pressure of 75 psi and an exhaust pressure 0 psi (atmospheric pressure). The simulation was run using the transient (unsteady) solver. The Stress-Omega based Reynolds Stress model was used to model turbulence. The ability of this model to accurately simulate highly anisotropic flows, such as swirling flows, and also capture near-wall flow separation, was considered a requirement for this analysis.

### Meshing

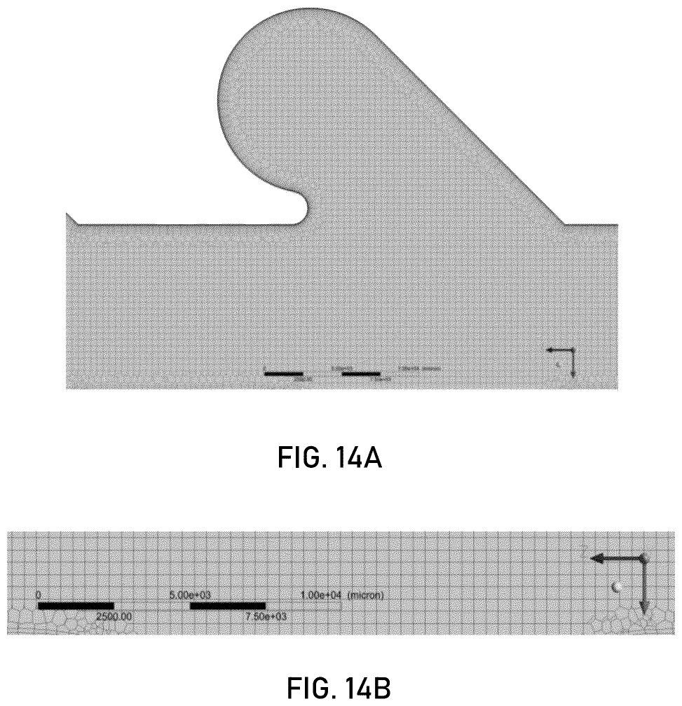

The 3D model was meshed using Fluent Meshing 2022 R2. Local refinement was provided throughout the central section of the device where stress gradients were expected to be highest, Boundary layer resolution next to the wall was captured with a maximum y+ value of 1.0. The final mesh consisted of 4.5 million cells. A close-up of the mesh in one of the conical torus expansion zones is shown in FIG. 14.

### Results

### Velocity

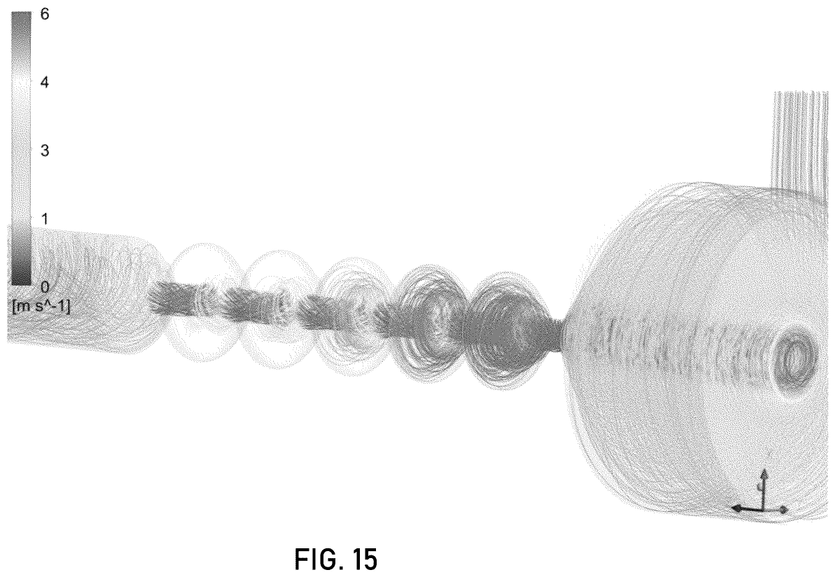

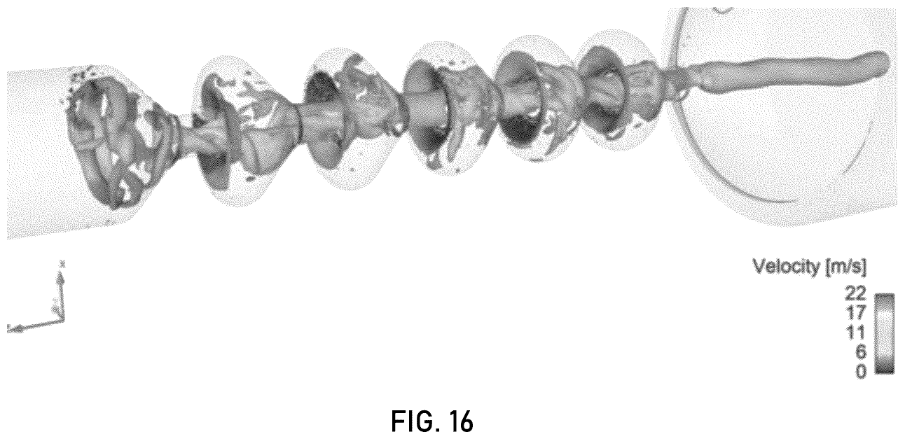

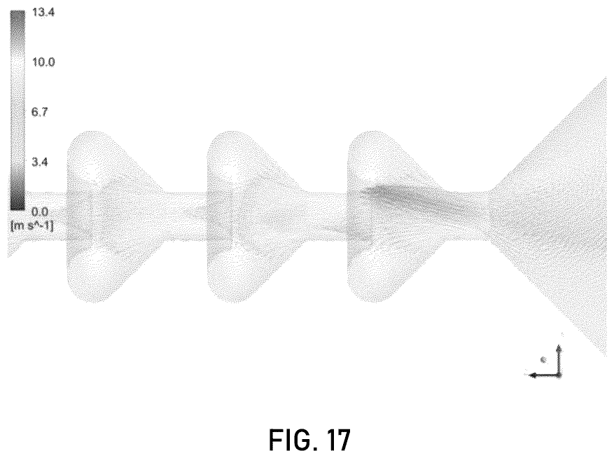

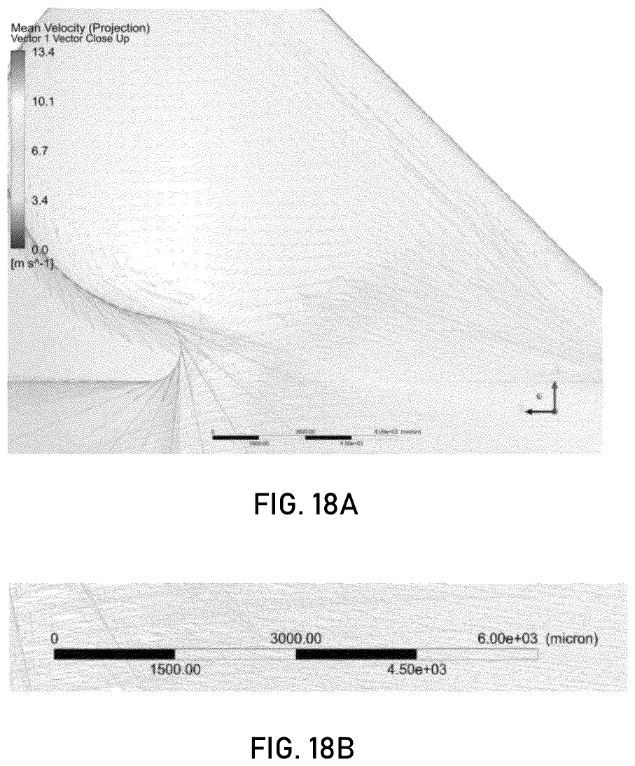

Modelling of velocity streamlines is shown in FIG. 15. FIG. 16 shows modelling of an iso-surface region of Q criterion, a measure of fluid rotation. It was observed that a vortex is present from the low radius region near the inlet and maintains its approximate shape until the exit region expansion zone. FIG. 17 and FIG. 18 show velocity vector plots using time-average values at the midplane of the Gas Dissolving Device.

Modelling shows radial expansion of flow within the dissolving chambers. However, the bulk of the flow was modelled to pass centrally through the dissolving chambers.

### Pressure and Cavitation

In initial analysis without cavitation modelling, localised regions where absolute pressure fell below zero were observed. This indicated that cavitation was likely to be occurring. Accordingly, analysis using the Zwart-Gerber-Belamri model (Zwart, Philip J., Andrew G. Gerber, and Thabet Belamri. “A two-phase flow model for predicting cavitation dynamics.” Fifth international conference on multiphase flow, Yokohama, Japan. Vol. 152. 2004) was performed.

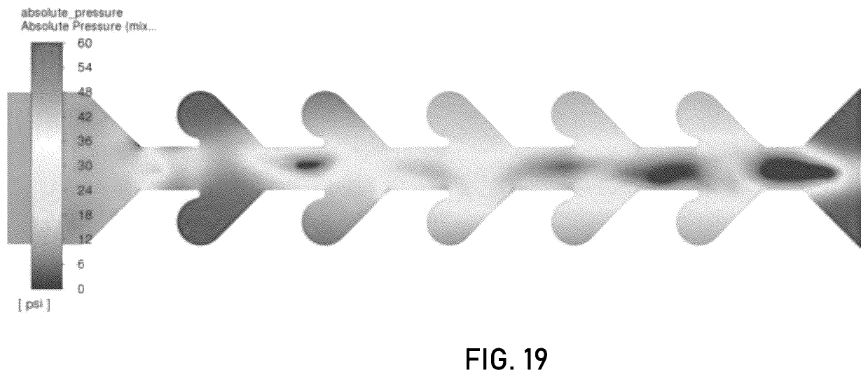

FIG. 19 shows a plot of absolute pressure in the range of 0-60 psi for modelling that included the effects of cavitation. It can be observed that pressure is generally highest in the toroidal regions towards the wider first end of the dissolving chambers towards the chamber outlets, and lower towards the narrower second ends of the dissolving chambers. Pressure is significantly lower still within the connecting channels, falling below zero in some places.

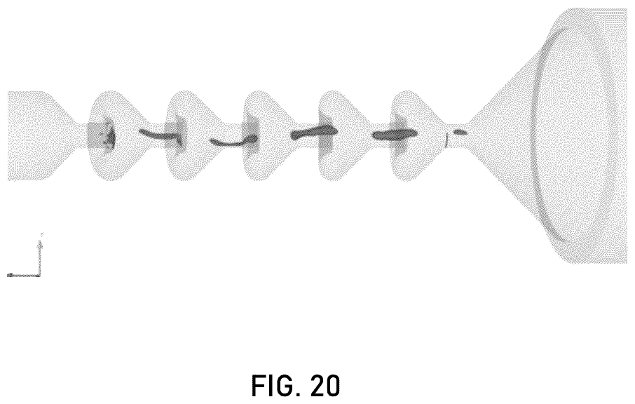

FIG. 20 shows a snapshot of modelling of vapour regions (red) induced by cavitation. The cavitation was observed to be dynamic, with variation in space and time of growth and collapse of vapour regions. The vast majority of cavitation was observed to occur within or adjacent to the connecting chambers.

### Discussion

Experimental analysis of bubble size produced by the gas dissolving device has shown that the device is capable of achieved dissolved gas with bubble size in the nanometre range (‘nanobubbles’). In view of the modelling results obtained, two mechanisms for bubble breakup are discussed.

### Bubble Breakup Due to Shear

For the purpose of assessing bubble breakup as a result of shear gradient, a dimensionless value referred to as the Weber number (We) can be used. The Weber number in a turbulent flow can be calculated in CFD using the following formula:

$$We = \frac{2 {ρε}^{2 / 3} {D}^{5 / 3}}{σ}$$

Where ρ is the liquid density, ε is the turbulent energy dissipation rate, D is the bubble diameter and σ is the surface tension.

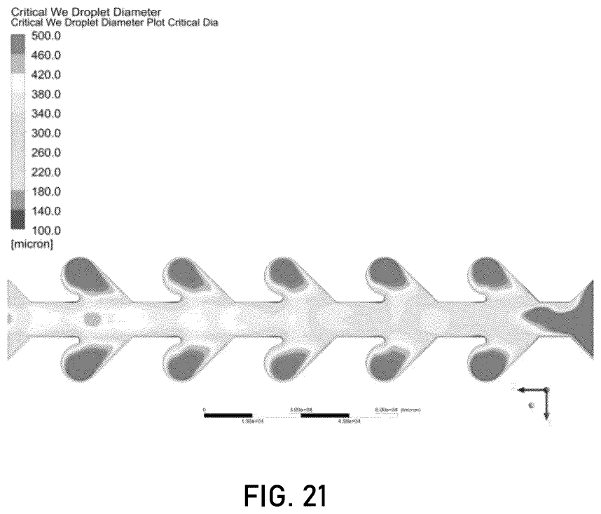

From a review of the literature (including X. Wang, Y. Shuai, H. Zhang, J. Sun and Y. Yang et al, “Bubble breakup in a swirl-venturi microbubble generator,” Chemical Engineering Journal 403, 2021), a Weber number of 7.0 was selected for purposes of CFD modelling using the above formula of a ‘Critical We Droplet Diameter’ within the gas dissolving device, which provides an indication of expected minimum bubble diameter based on bubble breakup due to shear gradients. Results of this modelling are shown in FIG. 21.

The results of the CFD modelling using the Weber number to assess bubble breakup in the gas dissolving device due to shear indicate, with the exception of certain very small near-wall regions where little flow was occurring, that the low range of critical bubble diameter was approximately 200-250 microns. The results suggest that bubble break up due to shear occurs within the gas dissolving device, but that shear gradients are unlikely to be responsible for the nanobubble generation that has been experimentally observed.

### Bubble Breakup Due to Cavitation

Cavitation is a phenomenon where local pressure falls below liquid vapour pressure resulting in the formation of vapour bubbles. In an industrial context, it is known that collapse of vapour bubbles formed due to cavitation can result in shock waves with force strong enough to damage machinery such as pumps, propellers, and flow restriction devices.

The CFD modelling performed for this assessment indicates that significant cavitation is likely to occur within the gas dissolving device, particularly centrally within or adjacent to the connecting chambers. Cavitation is likely to be enhanced by the succession of expanding and contracting radii of the dissolving chambers in the flow path direction.

As at the filing date, CFD modelling to accurately assess the effect of bubble breakup to form nanobubbles in the context of the gas dissolving device exceeds known available capability. However, a review of the literature identified research supporting potential for nanobubble generation due to cavitation (e.g. X. Wang, Y. Shuai, H. Zhang, J. Sun and Y. Yang et al, “Bubble breakup in a swirl-venturi microbubble generator,” Chemical Engineering Journal 403, 2021).

### Conclusion

CFD analysis was performed for a typical embodiment of a gas dissolving device according to an aspect of the invention. Experimental testing of the device had revealed that substantial production of dissolved gas in nanobubble size range was achieved by the device.

The CFD analysis revealed that turbulence and associated shear force likely contributed to bubble break up by the device, but that this was unlikely to be responsible for break up to nanobubble sizes. CFD analysis further revealed that the device achieved substantial cavitation. Based on a review of the literature in combination with experimental results, it is considered that cavitation is a key factor in the device producing dissolved gas with bubble size in the nanometre range.

### Example 3

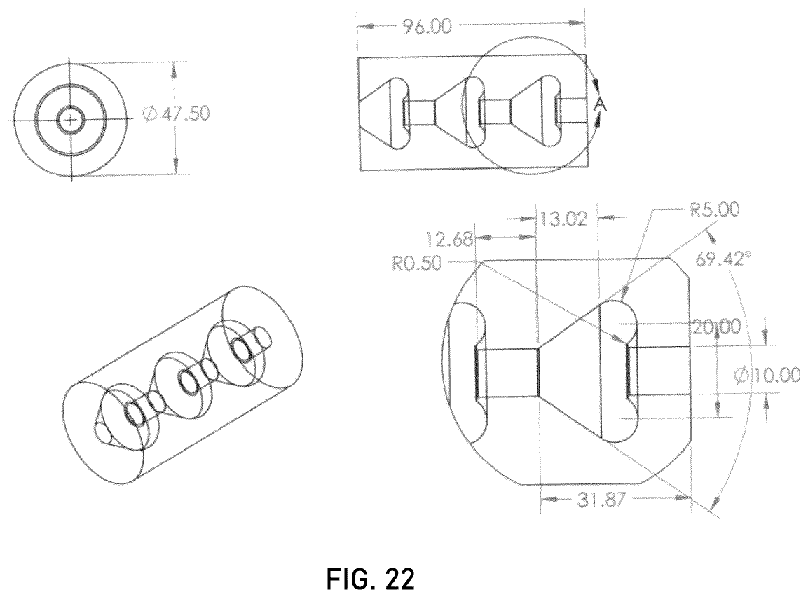

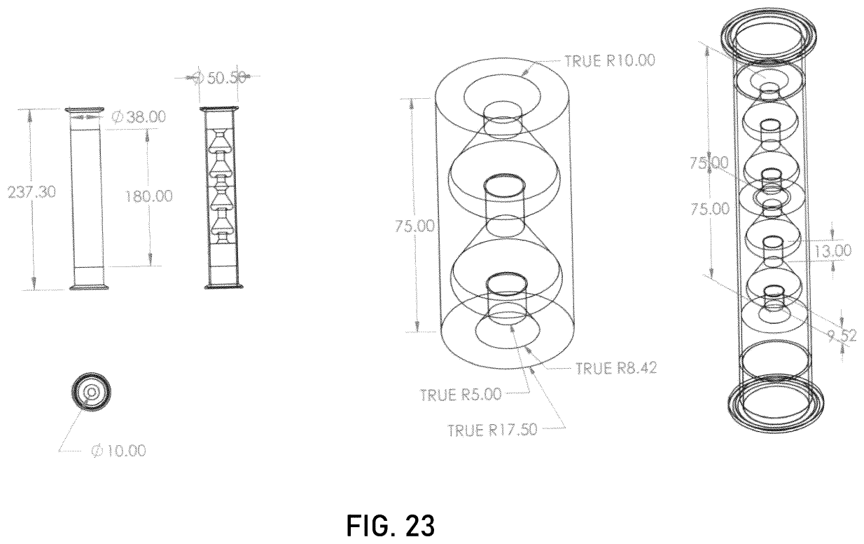

The following example details parameters of embodiments of the gas dissolving device as described herein, with reference to Table 1. More particularly, Table 1 sets out processing parameters of six dissolving chamber embodiments constructed to scale with reference to FIG. 22 and FIG. 23, with varying chamber connector diameters.

It will be fully understood that the scale range represented in Table 1 is not limiting. Devices smaller than the smallest scale represented and larger than the largest scale represented are also entirely possible and may be desirable in certain circumstances.

It will be further understood that parameters, including the gas volumes, referenced in Table 1 are exemplary and non-limiting, and depend on a range of factors including liquid and gas types and pumping capacity in the context of systems comprising the gas dissolving device.

At least certain typical embodiments of aspects of the invention as described herein may have particular benefits or advantages, some of which advantages have been discussed hereinabove. By way of further non-limiting example, certain benefits or advantages are discussed as follows.

Embodiments of the device as described herein can advantageously achieve relatively high concentrations of dissolved gas bubbles of nanometre size range. The very small bubble size achieved by devices as described herein is understood by the applicant to be advantageous for maintaining stability of dissolved gas in liquid. Without being bound by theory, several features of the device are considered to be advantageous for concentrating gas and/or minimising gas bubble size as has been described herein.

As herein described, in at least typical embodiments of the device, the chamber connectors and the inlets and outlets of the dissolving chambers define a substantially straight, substantially cylindrical passage or borehole extending through the body of the device. It will be appreciated that the passage or borehole provides for substantially open fluid flow along the length of the device.

The passage or borehole structure is considered advantageous in allowing for substantially continuous vortexing of fluid through the device. Substantially continuous vortexing of fluid within the device is considered advantageous in producing centrifugal force within the dissolving chambers and connecting channels, contributing to turbulence and shear force.

It is further noted that the passage or borehole structure of the device can be advantageous to allow for tolerance of solid particles that may be suspended in fluid, e.g. in relation to blockage.

The conical toroidal structure of dissolving chambers as described herein is considered advantageous for creating turbulence and shear force, and for creating differential pressure zones of fluid flow within the device.

The inclusion of relatively narrowed, cylindrical connecting channels adjacent conical, toroidal regions of the dissolving chambers is considered advantageous for creating turbulence and shear force, and for creating differential pressure zones of fluid flow within the device.

Notably, the combination of conical, toroidal regions of the dissolving chambers with the open central passage or borehole region is understood to create opposing fluid flow at or towards the toroidal region of the dissolving chambers relative to the central passage or borehole. This has been observed to create zones of high shear and high pressure within the dissolving chambers that would typically be considered to be regions of expansion and relatively low pressure.

Advantageously, the structure of the device including the toroidal regions of the dissolving chambers and the cylindrical connecting channels, and the open central passage or borehole region formed thereby, can produce opposing flow paths, points of shear force, differential pressure zones, and regions of cavitation without the need for moving parts.

The above factors and/or combinations thereof, are considered to contribute to the overall advantageous performance of the device, including production of relatively or comparatively high concentrations of dissolved gas and/or relatively or comparatively small dissolved gas bubble size.

It is also noted that, in typical use, cavitation is substantially restricted centrally within the connecting channels. This is understood to insulate the device body from force resulting from cavitation, thereby advantageously protecting the device from wear and deterioration and extending lifespan.

It will be understood generally that description of embodiments of the invention as provided herein is for purposes of description to one of ordinary skill in the related art. It is not intended to be exhaustive or to limit the invention to a single disclosed embodiment. In some instances, well-known components and/or processes have not been described in detail, so as not to obscure the embodiments described herein.

Numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations that have been discussed herein, and other embodiments that fall within the spirit and scope of the invention.

In particular, it will be clear that the specific number of dissolving chambers and connecting channels of devices as described herein can be varied. The applicant has found that use of six dissolving chambers and seven connecting channels has achieved highly desirable results in terms of dissolved gas concentration and dissolved gas bubble size. However, any suitable number of dissolving channels and connecting channels may be used.

In some embodiments, devices as described herein comprise between 3 and 10 dissolving chambers, including 4, 5, 6, 7, 8, and 9 dissolving chambers.

In some embodiments, devices as described herein comprise between 10 and 25 dissolving chambers, including 11, 12, 13, 14, 15, 16, 17, 18, 19, 20, 21, 22, 23, and 24 dissolving chambers.

In some embodiments, devices as described herein comprise between 4 and 11 connecting channels, including 5, 6, 7, 8, 9, and 10 connecting channels.

In some embodiments, devices as described herein comprise between 11 and 26 connecting channels, including 11, 12, 13, 14, 15, 16, 17, 18, 19, 20, 21, 22, 23, 24, and 25 connecting channels.

It has been made clear that the scale of devices as described herein can be widely varied depending on application, including with reference to Example 3.

It will be further understood that, although the particular shape of the dissolving chambers and connecting channels of devices 10-13 has been developed based on experimental optimisation conducted by the applicant, some variation to shape and dimensions is considered acceptable.

FIG. 22 and FIG. 23 sets forth certain relative dimensions of dissolving chambers and connecting channels of device 12, in particular. The relative dimensions of the dissolving chambers and connecting channels of devices 10, 11, and 13 are substantially the same or similar as set out in FIG. 22 and FIG. 23.

In some typical embodiments one or more, or all, relative dimensions of dissolving chambers and/or connecting channels of devices as described herein are within about +/−50%, +/−40%, +/−30%, +/−20%, or +/−10% of one or more corresponding relative dimensions set out in FIG. 22 and/or FIG. 23. In some typical embodiments one or more, or all, relative dimensions of dissolving channels and/or connecting channels of devices as described herein are within about +/−10%, +/−9%, +/−8%, +/−7%, +/−6%, +/−5%, +/−4%, +/−3%, +/−2%, or +/−1% of one or more corresponding relative dimensions set out in FIG. 22 and/or FIG. 23.

It will also be understood that, although devices and methods, etc., as described herein have focused on dissolving of gas in liquid, the invention may also have application for dissolving or blending of liquid in liquid. In particular, the skilled person will understand that arrangements as described herein, or modification thereof, may have application for combining a minor liquid or liquid component in a major liquid or solvent component.

It will be appreciated that aspects or embodiments of the invention may have application to formation of substantially homogenous mixtures of a plurality of aqueous liquids, or a plurality of oil-based liquids. It will be further appreciated that aspects or embodiments of the invention may have application to formation of emulsions of oil and water-based liquids.

It will also be appreciated that any of the liquids hereinabove described, inclusive of aqueous liquids, organic liquids, hydrocarbon liquids, non-aqueous inorganic liquids, and liquid metals, may form the minor liquid component or the major liquid component for arrangements wherein a liquid is blended or dissolved in another liquid.

In this specification, the use of the terms “suitable” and “suitably”, and similar terms, is not to be read as implying that a feature or step is essential, although such features or steps referred to as “suitable” may well be preferred.

In this specification, the indefinite articles “a” and “an” are not to be read as singular indefinite articles or as otherwise excluding more than one or more than a single subject to which the indefinite article refers. For example, “a” chamber includes one chamber, one or more chambers, and a plurality of chambers.

In this specification, the terms “comprises”, “comprising”, “includes”, “including”, and similar terms, are intended to denote the inclusion of a stated integer or integers, but not necessarily the exclusion of another integer or other integers, depending on context. That is, a device, system, or method, etc., that comprises or includes stated integer(s) need not have those integer(s) solely, and may well have at least some other integers not stated, depending on context.

In this specification, the terms “consisting essentially of” and “consists essentially of” are intended to mean a non-exclusive inclusion only to the extent that, if additional elements are included beyond those elements recited, the additional elements do not materially alter basic and novel characteristics. That is, a device, system, or method that “consists essentially of” one or more recited elements includes those elements only, or those elements and any additional elements that do not materially alter the basic and novel characteristics of the device, system, or method.

In this specification, terms such as “above” and “below”; “front” and “back”; “top” and “bottom”; “left” and “right”; “horizontal” and “vertical”, and the like, may be used for descriptive purposes. However, it will be understood that embodiments can potentially be arranged in various orientations, and that such relative terms are not limiting and may be interchangeable in appropriate circumstances.

In this specification, unless the context requires otherwise, the terms “connection”, “connected”, “connecting”, and the like, are not to be read as limited to direct connections and may also include indirect connections. For example, unless the context requires otherwise, a stated first component “connected” to a stated second component may be connected via, through, or by, one or more unstated components.

TABLE 1
Processing parameters of embodiments of the gas diffuser
device as described herein of varying scales.

| | | | | | | | | Gas litres/ |
|---|---|---|---|---|---|---|---|---|
| Model | Diameter | L/min | L/hour | L/day | gal/min | gal/hour | gal/day | minute |
| GI-5k | 10 mm | 80 | 5,000 | 120,000 | 21 | 1,320 | 31,700 | 0.4-0.8 |
| GI-10k | 13 mm | 160 | 10,000 | 240,000 | 42 | 2,640 | 63,400 | 0.8-1.6 |
| GI-15k | 16 mm | 250 | 15,000 | 360,000 | 66 | 4,000 | 95,100 | 1.25-2.5 |
| GI-20k | 18 mm | 330 | 20,000 | 480,000 | 87 | 5,280 | 126,800 | 1.6-3.3 |
| GI-25k | 20 mm | 420 | 25,000 | 600,000 | 110 | 6,600 | 158,500 | 2.0-4.0 |
| GI-30k | 22 mm | 500 | 30,000 | 720,000 | 132 | 7,900 | 190,200 | 2.5-5.0 |
| GI-40k | 25 mm | 660 | 40,000 | 960,000 | 174 | 10,500 | 253,600 | 3.3-6.6 |
| GI-50k | 28 mm | 830 | 50,000 | 1,200,000 | 220 | 13,200 | 317,000 | 4.1-8.2 |
| GI-60k | 31 mm | 1,000 | 60,000 | 1,440,000 | 264 | 15,850 | 380,400 | 5.0-10.0 |
| GI-70k | 33 mm | 1,160 | 70,000 | 1,680,000 | 306 | 18,500 | 444,000 | 5.8-11.6 |
| GI-80k | 35 mm | 1,330 | 80,000 | 1,920,000 | 350 | 21,100 | 507,200 | 6.6-13.3 |
| GI-90k | 37 mm | 1,500 | 90,000 | 2,160,000 | 400 | 23,775 | 570,600 | 7.5-15.0 |
| GI-100k | 39 mm | 1,660 | 100,000 | 2,400,000 | 440 | 26,420 | 634,000 | 8.3-16.6 |

1. A device for dissolving a gas in a liquid, the device comprising a device body, the device body comprising a liquid inlet; a liquid outlet; a plurality of substantially conical dissolving chambers located between the liquid inlet and the liquid outlet; and a plurality of chamber connectors of or connected with the dissolving chambers, wherein:
each of the plurality of conical dissolving chambers comprise a wider substantially toroidal end towards the liquid outlet, the wider end comprising a chamber outlet for flow of liquid out of the dissolving chamber; and a narrower end towards the liquid inlet, the narrower end comprising a chamber inlet for flow of liquid into the dissolving chamber, and
the plurality of chamber connectors define a substantially longitudinally straight passage extending through the plurality of dissolving chambers.

2. (canceled)

3. The device of claim 1, wherein the liquid outlet is situated substantially centrally within the substantially toroidal end.

4. The device of claim 1, wherein the chamber connectors are substantially cylindrical chamber connectors.

5. The device of claim 4, wherein the passage extending through the plurality of dissolving chambers is a substantially cylindrical passage.

6. The device of claim 1, comprising at least three dissolving chambers.

7. The device of claim 1, comprising at least five dissolving chambers.

8. The device of claim 1:
one or more of the plurality of dissolving chambers and one or more of the plurality of chamber connectors are of a central portion of the body of the device;
the liquid inlet is of a base portion of the body of the device, the base portion comprising a substantially conical chamber, wherein a narrower end of the substantially conical chamber of the base portion is located away from the liquid inlet; and
the liquid outlet is of a tip portion of the device, the tip portion of the device comprising a substantially conical chamber, wherein a narrower end of the substantially conical chamber of the tip portion is located away from the liquid outlet.

9.-10. (canceled)

11. The device of claim 1, wherein the device body is a unitary body.

12. The device of claim 1, wherein the device body is a modular body.

13. The device of claim 12, wherein the modular body comprises at least three separatable modules, wherein:
a base portion of the body of the device comprises at least one of the separatable modules;
a tip portion of the body of the device comprises at least one of the separatable modules; and
a central portion of the body of the device comprises at least one of the separatable modules.

14.-18. (canceled)

19. A method of adjusting the modular device of claim 12, including a step of adding and/or removing one or more separatable modules of the device.

20. A method of dissolving a gas in a liquid, the method including a step of passing fluid comprising liquid and gas through a plurality of substantially conical dissolving chambers via a substantially longitudinally straight passage extending through the plurality of dissolving chambers, each of the plurality of dissolving chambers comprising a wider substantially toroidal end, the wider end comprising a chamber outlet for flow of liquid out of the dissolving chamber, and a narrower end, the narrower end comprising a chamber inlet for flow of liquid into the dissolving chamber, the substantially longitudinally straight passage defined by a plurality of chamber connectors, the plurality of chamber connectors of or connected with the dissolving chambers.

21.-22. (canceled)

23. The method of claim 20, including a-steps of:
substantially continuously vortexing the fluid through the substantially longitudinally straight passage defined by the plurality of chamber connectors;
inducing shear force in the fluid;
inducing regions of negative pressure in the fluid; and/or
inducing cavitation in the fluid.

24.-32. (canceled)

33. The method of claim 20, including a step of producing an average bubble size of the gas dissolved in the liquid of less than about 1000 nm or less than about 100 nm.

34. (canceled)

35. The method of claim 20, including a step of inputting the liquid at a pressure of between about 10 psi and about 200 psi or between about 60 psi and about 110 psi.

36. (canceled)

37. The method of claim 20, wherein the liquid is or comprises water.

38. The method of claim 20, wherein the liquid is or comprises a hydrocarbon liquid.

39. The method of claim 20, wherein the gas is or comprises hydrogen gas.

40. The method of claim 20, wherein the gas is air or is derived from air or water.

41. (canceled)

42. The method of claim 20, wherein the gas is or comprises a noble gas.
